(19) United States
(12) Patent Application Publication
(10) Pub. No.: US 2010/0011176 A1
(43) Pub. Date: Jan. 14, 2010

(54) Performance of binary bulk IO operations on virtual disks by interleaving

(76) Inventor: Todd R. Burkey, Savage, MN (US)

Correspondence Address: BECK AND TYSVER P.L.L.C., 2900 THOMAS AVENUE SOUTH, SUITE 100, MINNEAPOLIS, MN, 55416, US

(21) Appl. No.: 12/218,207

(22) Filed: Jul. 11, 2008

(51) Int. Cl. G06F 12/06; G06F 12/08

(52) U.S. Cl. 711/157; 711/114; 711/E12.079; 711/E12.019

(57) ABSTRACT

A method and system are provided for executing a binary bulk input/output (IO) operation on a first virtual disk and a second virtual using interleaving. The performance improvement due to the method is expected to increase as more information about the configuration of the virtual disks and their implementation are taken into account. Aspects of a binary bulk IO operation, which distinguish it from a unary bulk IO operation, are collection of information regarding both virtual disks and consideration of performance factors on both virtual disks, individually and jointly. Performance factors considered may include contention among tasks implementing the parallel process, load on the storage system(s) from other processes, performance characteristics of components of the storage system(s), and the virtualization relationships (e.g., mirroring, striping, and concatenation) among physical and virtual storage devices within the virtual configuration.

### CROSS-REFERENCES TO RELATED APPLICATIONS

This application is related to U.S. patent application Ser. No. ______, entitled “Improving Performance of Unary Bulk IO Operations on Virtual Disks by Interleaving,” filed Jul. 11, 2008, having inventor Todd R. Burkey, which is hereby incorporated in this application by reference.

### FIELD OF THE INVENTION

The present invention relates to the field of data storage, and, more particularly, to performing binary bulk IO operations on two virtual disks using interleaving.

### BACKGROUND OF THE INVENTION

Storage virtualization inserts a logical abstraction layer or facade between one or more computer systems and one or more physical storage devices. Virtualization permits a computer to address storage through a virtual disk (VDisk), which responds to the computer as if it were a physical disk (PDisk). Unless otherwise specified in context, we will use the abbreviation PDisk herein to represent any digital physical data storage device, for example, conventional rotational media drives, Solid State Drives (SSDs) and magnetic tapes. A VDisk may be implemented using a plurality of physical storage devices, configured in relationships that provide redundancy and improve performance.

Virtualization is often performed within a storage area network (SAN), allowing a pool of storage devices with a storage system to be shared by a number of host computers. Hosts are computers running application software, such as software that performs input and/or output (IO) operations using a database. Connectivity of devices within many modern SANs is implemented using Fibre Channel technology, although many types of communications or networking technology are available. Ideally, virtualization is implemented in a way that minimizes manual configuration of the relationship between the logical representation of the storage as one or more VDisks, and the implementation of the storage using PDisks and/or other VDisks. Tasks such as backing up, adding a new PDisk, and handling failover in the case of an error condition should be handled by a SAN as automatically as possible.

In effect, a VDisk is a facade that allows a set of PDisks and/or VDisks, or more generally a set of portions of such storage devices, to imitate a single PDisk. Hosts access the VDisk through a virtualization interface. Virtualization techniques for configuring the storage devices behind the VDisk facade can improve performance and reliability compared to the more traditional approach of a PDisk directly connected to a single computer system. Standard virtualization relationships include mirroring, striping, concatenation, and writing parity information.

Mirroring involves maintaining two or more separate copies of data on storage devices. Strictly speaking, a mirroring relationship maintains copies of the contents/data within an extent, either a real extent or a virtual extent. The copies are maintained on an ongoing basis over a period of time. During that time, the data within the mirrored extent might change. When we say herein that data is being mirrored, it should be understood to mean that an extent containing data is being mirrored, while the content itself might be changing.

Typically, the mirroring copies are located on distinct storage devices that, for purposes of security or disaster recover, are sometimes remote from each other, in different areas of a building, different buildings, or different cities. Mirroring provides redundancy. If a device containing one copy, or a portion of a copy, suffers a failure of functionality (e.g., a mechanical or electrical problem), then that device can be serviced or removed while one or more of the other copies is used to provide storage and access to existing data. Mirroring can also be used to improve read performance. Given copies of data on drives A and B, then a read request can be satisfied by reading, in parallel, a portion of the data from A and a different portion of the data from B. Alternatively, a read request can be sent to both A and B. The request is satisfied from either A or B, whichever returns the required data first. If A returns the data first then the request to B can be cancelled, or the request to B can be allowed to proceed, but the results will be ignored. Mirroring can be performed synchronously or asynchronously. Mirroring can degrade write performance, since a write to create or update two copies of data is not completed until the slower of the two individual write operations has completed.

Striping involves splitting data into smaller pieces, called “stripes.” Sequential stripes are written to separate storage devices, in a round-robin fashion. For example, suppose a file or dataset were regarded as consisting of six contiguous extents of equal size, numbered 1 to 6. Striping these extents across three drives would typically be implemented with parts 1 and 4 as stripes on the first drive; parts 2 and 5 as stripes on the second drive; and parts 3 and 6 as stripes on the third drive. The stripes, in effect, form layers, called “strips” within the drives to which striping occurs. In the previous example, stripes 1, 2, and 3 form the first strip; and stripes 4, 5, and 6, the second. Striping can improve performance on conventional rotational media drives because data does not need to be written sequentially by a single drive, but instead can be written in parallel by several drives. In the example just described, stripes 1, 2, and 3 could be written in parallel. Striping can reduce reliability, however, because failure of any one of the storage devices holding a stripe will render unrecoverable the data in the entire copy that includes the stripe. To avoid this, striping and mirroring are often combined.

Writing of parity information is an alternative to mirroring for recovery of data upon failure. In parity redundancy, redundant data is typically calculated from several areas (e.g., 2, 4, or 8 different areas) of the storage system and then stored in one area of the storage system. The size of the redundant storage area is less than the remaining storage area used to store the original data.

A Redundant Array of Independent (or Inexpensive) Disks (RAID) describes several levels of storage architectures that employ the above techniques. For example, a RAID 0 architecture is a striped disk array that is configured without any redundancy. Since RAID 0 is not a redundant architecture, it is often omitted from a discussion of RAID systems. A RAID 1 architecture involves storage disks configured according to mirror redundancy. Original data is stored on one set of disks and duplicate copies of the data are maintained on separate disks. Conventionally, a RAID 1 configuration has an extent that fills all the disks involved in the mirroring. An extent is a set of consecutively addressed storage units. (A storage unit is the smallest unit of storage within a computer system, typically a byte or a word.) In practice, mirroring sometimes only utilizes a fraction of a disk, such as a single partition, with the remainder being used for other purposes. Also, mirrored copies might themselves be RAIDs or VDisks. The RAID 2 through RAID 5 architectures each involves parity-type redundant storage. RAID 10 is simply a combination of RAID 0 (striping) and RAID 1 (mirroring). This RAID type allows a single array to be striped over more than two physical disks with the mirrored stripes also striped over all the physical disks.

Concatenation involves combining two or more disks, or disk partitions, so that the combination behaves as if it were a single disk. Not explicitly part of the RAID levels, concatenation is a virtualization technique to increase storage capacity behind the VDisk facade.

Virtualization can be implemented in any of three storage system levels—in the hosts, in the storage devices, or in a network device operating as an intermediary between hosts and storage devices. Each of these approaches has pros and cons that are well known to practitioners of the art.

Various types of storage devices are used in current data processing systems. A typical system may include one or more large capacity tape units and/or disk drives (magnetic, optical, or semiconductor) connected to the systems through respective control units for storing data. Virtualization, implemented in whole or in part as one or more RAIDs, is an excellent method for providing high speed, reliable data storage and file serving, which are essential for any large computer system.

A VDisk is usually represented to the host by the storage system as a logical unit number (LUN) or as a mass storage device. Often, a VDisk is simply the logical combination of one or more RAIDs.

Because a VDisk emulates the behavior of a PDisk, virtualization can be done hierarchically. For example, a VDisk containing two 200 gigabyte (200 GB) RAID 5 arrays might be mirrored to a VDisk that contains one 400 GB RAID 10 array. More generally, each of two VDisks that are virtual copies of each other might have very different configurations in terms of the numbers of PDisks, and the relationships being maintained, such as mirroring, striping, concatenation, and parity. Striping, mirroring, and concatenation can be applied to VDisks as well as PDisks. A virtualization configuration of a VDisk can itself contain other VDisks internally. Copying one VDisk to another is often an early step in establishing a VDisk mirror relationship. A RAID can be nested within a VDisk or another RAID; a VDisk can be nested in a RAID or another VDisk.

A goal of the VDisk facade is that an application server can be ignorant of the details of how the VDisk is configured, simply regarding the VDisk as a single extent of contiguous storage. Examples of operations that can take advantage of this pretense include reading a portion of the VDisk; writing to the VDisk; erasing a VDisk; initializing a VDisk; and copying one VDisk to another.

Erasing and initializing both involve setting the value of each storage location within the VDisk, or some subextent of the VDisk, to zero. This can be achieved by iterating through each storage cell of the VDisk sequentially, and zeroing the cell.

Copying can be done by sequentially reading the data from each storage cell of a source VDisk and writing the data to a target VDisk. Note that copying involves two operations and potentially two VDisks.

Typically, a storage system is managed by logic, implemented by some combination of hardware and software. We will refer to this logic as a controller of the storage system. A controller typically implements the VDisk facade and represents it to whatever device is accessing data through the facade, such as a host or application server. Controller logic may reside in a single device or be dispersed over a plurality of devices. A storage system has at least one controller, but it might have more. Two or more controllers, either within the same storage system or different ones, may collaborate or cooperate with each other.

Some operations on a VDisk are typically initiated and executed entirely behind the VDisk facade; examples include scrubbing a VDisk, and rebuilding a VDisk. Scrubbing involves reading every sector on a PDisk and making sure that it can be read. Optionally, scrubbing can include parity checking, or checking and correcting mirroring within mirrored pairs.

A VDisk may need to be rebuilt when the contents of a PDisk within the VDisk configuration contains the wrong information. This might occur as the result of an electrical or mechanical failure, an upgrade, by a temporary interruption in the operation of the disk. Assuming a correct mirror or copy of the VDisk exists, then rebuilding can be done by copying from the mirror. If no mirror or copy exists, it will usually be impossible to perform a rebuild at the VDisk level.

### SUMMARY OF THE INVENTION

Storage capacities of VDisks, as well as PDisks or RAIDs implementing them, increase with storage requirements. Over the last decade, the storage industry has seen a typical PDisk size increase from 1 GB per device to 1,000 GB per device and the total number of devices in a RAID increase from 24 to 200, a combined capacity increase of about 8,000 times. Performance has not kept pace with increases in capacity. For example, the ability to copy “hot” in-use volumes has increased from about 10 MB/s to about 100 MB/s, a factor of only 10. The improvements in copying have been due primarily to faster RAID controllers, faster communications protocols, and better methods that selectively omit copying portions of disks that are known to be immaterial (e.g., portions of the source disk that have never been written to, or that are known to already be the same on both source and target).

The inventor has recognized that considerable performance improvements can be realized when the controller is aware that an IO operation affecting an subextent of the VDisk, which could be the entire VDisk, is required. The improvements are achieved by dividing up the extent into smaller chunks, and processing them in parallel. Because completion of the chunks will be interleaved, the operation must be such that portions of the operation can be completed in any order. We will refer to such an IO operation as a “bulk IO operation.” The invention generally does not apply to operations such as audio data being streamed to a headset, where the data must be presented in an exact sequence. Examples of bulk IO operations include certain read operations; write operations; and other operations built upon read and write operations, such as initialization, erasing, rebuilding, and scrubbing. Copying (along with operations built upon copying) is a special case in that it typically involves two VDisks, so that some coordination may be required. The source and target may be in the same storage system, or different storage systems. One or more controllers may be involved. Information will need to be gathered about both VDisks, and potentially the implementations of their respective virtualization configurations.

Operations not invoked through the VDisk facade might be triggered, for example, by an out-of-line communication to the controller from a host external to the storage system requesting that the operation be performed; by the controller itself or other logic within the storage system initiating the operation; or by a request from a user to the controller. An out-of-line request is a request that is received through a communication path that does not include, or bypasses, the virtualization interface of the virtual disk. An out-of-line user request will typically be entered manually through a graphical user interface. Reading, writing, erasing, initializing, copying, and other tasks might be invoked by these means as well, without going through the VDisk facade.

Performance improvements are achieved through the invention by optimization logic that carries out the bulk IO operation using parallel processing, in many embodiments taking various factors affecting performance into account. Note that reading, writing, initialization, erasing, rebuilding, and copying may make sense at either the VDisk or the PDisk level. Scrubbing is typically implemented only for PDisks.

Consider some extent E of a VDisk, which might be the entire extent of the VDisk or some smaller portion. In some embodiments of the invention, E is itself partitioned into subextents or chunks. The parallelism is achieved by the invention by making separate requests to storage devices to process individual chunks as tasks within the bulk IO operation. (We use the word “task” generically, as some set of steps that are performed, and without any particular technical implications.) At any given time, two or more chunks may be processed simultaneously by tasks as a result of the requests. In some embodiments of the invention, the tasks are implemented as threads. Instructions from a processor execute in separate threads simultaneously or quasi-simultaneously. A plurality of tasks are utilized in carrying out the bulk IO operation. The number of tasks executing at any given time is less than or equal to the number of chunks. Each task will carry out a portion of the bulk IO operation that is independent in execution of the other tasks. In other embodiments, a plurality of tasks are triggered by a thread making separate requests for processing of chunks in parallel, for example to the storage devices. Because IO operations are slow relative to activities of a processor, even a single thread running in the processor can generate and transmit requests for task execution sufficiently quickly that the requests can be processed in parallel by the storage devices.

Certain operations may use a buffer or a storage medium. For example, a bulk copy operation may read data from a source into a buffer, and then write the data from the buffer to a target. The data held in the buffer may be all or part of the data being copied.

Bulk IO operations can be divided into two types, unary and binary. Reading, writing, initialization, erasing, rebuilding, and scrubbing are unary operations in that they involve a single top level virtual disk. Copying and other processes based upon copying are binary bulk IO operations because they involve two VDisks that must be coordinated. Because copying will be used herein as exemplary of the binary bulk IO operations, we will sometimes refer to these VDisks as the “source” and “target” VDisks. It should be understood that, with respect to more general binary bulk IO operations to which the invention applies, a “source” and a “target” should be regarded as simply a first and a second VDisk, respectively.

The choice of how to divide the extent of the VDisk into chunks, the timing and order of execution of the tasks, and other aspects of the parallelizing a bulk IO operation can be implemented with varying degrees of sophistication. We will describe three different approaches found in embodiments of the invention: Basic, Intermediate, and Advanced. Some approaches may be limited to certain classes of virtualization configurations.

In the Basic Approach, each task executes as if a host had requested that task through the VDisk's facade on a chunk. The tasks will actually be generated by the controller, but will use the standard logic implementing the virtual interface to execute. Sending all requests to the VDisk and ignoring details of PDisk implementation, the Basic Approach is not appropriate for an operation that is specific to a PDisk, such as certain scrubbing and rebuilding operations.

The amount of performance improvement achieved by the Basic Approach will depend upon the details of the virtualization configuration. In one example of this dependence, two tasks running simultaneously might access different PDisks, which would result in a performance improvement. In another example, two tasks may need to access the same PDisk simultaneously, meaning that one will have to wait for the other to finish. Since the Basic Approach ignores details of the virtualization configuration, the amount of performance improvement achieved involves a stochastic element.

The Intermediate Approach takes into account more information than the Basic Approach, and applies to special cases where, in selecting chunks and assigning tasks, a controller exploits some natural way of partitioning into subextents a VDisk upon which a bulk IO operation is being performed. In one variation of the Intermediate Approach, the extent of the VDisk affected by the bulk IO operation can be regarded as partitioned naturally into subextents, where each subextent corresponds to a RAID. The RAIDs might be implemented at any RAID level as described herein, and different subextents may correspond to different RAID levels. Each such subextent is processed with a task, the number of tasks executing simultaneously being less than or equal to the number of subextents. In some embodiments, the IO operation on the subextent may be performed as if an external host had requested the operation on that subextent through the VDisk facade. In other embodiments, the controller may more actively manage how the subextents are processed by working with one or more individual composite RAIDs directly.

In another variation of the Intermediate Approach, the extent of the VDisk can again be regarded as partitioned logically into subextents. Each subextent corresponds to an internal VDisk, nested within the “top level” VDisk (i.e., the VDisk upon which the bulk IO operation is to be performed), the nested VDisks being concatenated to form the top level VDisk. Each internal VDisk might be implemented using any VDisk configuration. Each such subextent is processed by a task, the number of tasks executing simultaneously being less than or equal to the number of subextents. In some embodiments, the IO operation on the subextent will be performed as if an external host had requested the operation on that subextent through the VDisk facade. In other embodiments, the controller may more actively manage how the subextents are processed by working with one or more individual internal VDisks directly.

A third variation of the Intermediate Approach takes into account the mapping of the VDisk to the PDisks implementing the VDisk in the special case where data is striped across a plurality of PDisks with a fixed stripe size. The chunk size is no greater than the stripe size, and evenly divides the stripe size. In other words, the remainder when the stripe size (an integer) upon integer division by the chunk size (also an integer) is zero. The controller is aware of this striping configuration. In the case of a read operation or a write operation (including, for example, an initialize or erase operation), tasks are assigned in a manner such that each task corresponds to a stripe. In this arrangement, typically (but not necessarily) no two tasks executing simultaneously will be assigned to stripes on the same PDisk. This implies that the number of tasks executing simultaneously at any given time will typically be less than or equal to the number of PDisks.

The Intermediate Approach may ignore the details of the internal VDisk or internal RAID, and simply invoke the internal structure through the facade interface of the internal VDisk. Alternatively, the Intermediate Approach might issue an out-of-line command to an internal VDisk or RAID, assuming that is supported, thereby delegating to the logic for that interior structure the responsibility to handle the processing.

Some embodiments of the Intermediate Approach take into account load on the VDisks and/or PDisks involved in the bulk IO operation. For example, a conventional rotational media storage device can only perform a single read or write operation at a time. Tasks may be assigned to chunks in a sequence that attempts to maximize the amount of parallelization throughout the entire process of executing the IO operation in question. To avoid contention, in some embodiments, no two tasks are assigned to execute at the same time upon the same rotational media device, or other device that cannot be read from or written to simultaneously by multiple threads.

It is possible, however, that the storage devices will be accessed by processes other than the tasks of the bulk IO operation in question, thereby introducing another source of contention. Disk load from these other processes are taken into account by some embodiments of the invention. Such load may be monitored by the controller or by other logic upon request of the controller. Determination of disk load considers factors including queue depth, number of transactions over a past interval of time (e.g., one second); bandwidth (MB/s) over a past interval of time; latency; and thrashing factor.

More intelligent than the Intermediate Approach, which is aimed at bulk IO operations in which the VDisk data has a simple natural relationship to its configuration, the Advanced Approach considers more general relationships between the extent of the top level VDisk (i.e., the subject of the bulk IO operation) and inferior VDisks and PDisks within its virtualization configuration. A virtualization configuration can typically be represented as a tree. The Advanced Approach can be applied to complex, as well as simple, virtualization trees. Information about the details of the tree will be gathered by the controller. Some internal nodes in the virtualization tree may themselves be VDisks. Information might be gained about the performance of such an internal VDisk either by an out-of-band inquiry to the controller of the internal VDisk or by monitoring and statistical analysis managed by the controller.

Depending upon embodiment, the Advanced Approach may take into account some or all of the following factors, among others: (1) contention among PDisks or VDisks, as previously described; (2) load on storage devices due to processes other than the bulk IO operation; (3) monitored performance of internal nodes within the virtualization tree—an internal node might be a PDisk, an actual VDisk, or an abstract node; (4) information obtained by inquiry of an internal VDisk about the virtualization configuration of that internal VDisk; (5) forecasts based upon statistical modeling of historical patterns of usage of the storage array, performance characteristics of PDisks and VDisks in the storage array, and performance characteristics of communications systems implementing the storage system (e.g., Fibre Channel transfers blocks of information at a faster unit rate for blocks sizes in a certain range).

Taking into account some or all of these factors, the controller 105 can apply logic to decide when to process a chunk 800 of data, what the boundaries of the chunk 800 should be, how to manage tasks 1220, and which storage devices to use in the process. For example, a decision may be made, for example, about which copy from a plurality of mirroring storage devices (whether VDisks 125 or PDisks 120) to use in the bulk IO operation.

More advanced decision-making processes may also be used. For example, one or more statistical or modeling techniques (e.g., time series analysis; regression; simulated annealing) well-known in the statistical, forecasting, or mathematical arts may be applied by the controller to information obtained regarding these factors in selecting particular storage devices (physical or virtual) to use, selecting chunks (of uniform or varying sizes) on those storage devices, determining how many threads will be running at any particular time, and assigning threads to particular chunks.

Some techniques for prediction using time series analysis, which might be used by decision-making logic in the controller taking described, for example, by G. E. P. Box, G. M. Jenkins, and G. C. Reinsel, “Time Series Analysis: Forecasting and Control”, Wiley, 4th ed. 2008. Some methods for predicting the value of a variable based on available data, such as historical data, are discussed, for example, by T. Hastie, R. Tibshirani, and J. H. Friedman in “The Elements of Statistical Learning”, Springer, 2003. Various techniques for minimizing or maximizing a function are provided by W. H. Press, S. A. Teukolsky, W. T. Vetterling, and B. R. Flannery, “Numerical Recipes: The Art of Scientific Computing”, Cambridge Univ. Press, 3rd edition 2007. The Box et al., Hastie et al., and Press et al. texts are hereby incorporated by reference into this specification.

In some embodiments, implementation of the IO operation is done recursively. A parent (highest level) VDisk might be regarded as a configuration of child internal VDisks. Performing the operation upon the parent will require performing it upon the children. Processing a child, in turn, can itself be handled recursively.

Binary bulk IO operations, such as bulk copy operations, are complicated by the fact that two top level VDisk configurations will be involved, and those configurations might be the same or different. Each of the VDisks might be handled by a bulk copy analogously to the Basic, Intermediate, or Advanced Approaches already described. Ordinarily, the two VDisks will be typically handled with the same approach, although this will not necessarily be the case. All considerations previously discussed for read and write operations apply to the read and write phases of the analogous copy operations approaches. However, binary bulk IO operations may involve exchanges of information, and joint control, which are not required for unary bulk IO operations.

With all three approaches, the fundamental methodology in a binary bulk IO operation, typified by a bulk copy, is the same. Tasks are responsible for copying the corresponding extent from source to target VDisk. Any or all the factors affecting performance already discussed may be taken into account, potentially considering both source and target VDisk implementations jointly. Note that the two VDisks may be in the same storage system or in different storage systems. Copying occurs under the direction of a controller, for example, the source VDisk controller. If there is a second controller, for example the target controller, then the two controllers will have to at least exchange information. The controller managing the operation may issue commands to the other controller. If there is just a single controller, that controller must manage the binary bulk IO operation on both virtualization configurations. The controller may perform other management tasks for the operation, such as creating and managing a buffer, or creating and initializing a target VDisk. Extents on both the first and second VDisks are divided into a common number subextents, corresponding subextents on the two VDisks being the same in location and size. A task processes a pair of corresponding subextents.

In the Basic Approach, as applied to a binary bulk IO operation, a controller assigns a subextent to a task, the task then accessing the first and second VDisks through their virtualization facades, behaving much like a host accessing the VDisks inline. The Basic Approach ignores details of the two virtualization configurations. Note that a “task” implementing a portion of any binary bulk IO operation is conceptual—it might actually represent a first subtask performing a first operation (e.g., a read) followed by a subsequent subtask performing a second operation (e.g., a write).

In some embodiments of any of the approaches, data from the source is copied directly from source PDisks and/or VDisks (top level or internal) to those of the target. More typically, however, data from source PDisks and/or VDisks is copied into a buffer; data in the buffer is subsequently copied to target PDisks and/or VDisks. Even if the data is buffered, there is a performance advantage if the sizes of the chunks from the source and those from the target are fixed and related. Since, in general, chunks can be copied in any order, bookkeeping is significantly reduced if the source chunk size evenly divides the target chunk size, or conversely. (If A and B are integers, A “evenly divides” B if the remainder after integer division of B by A is zero.)

In some embodiments of interleaved, or parallel, copying using the Intermediate Approach, the extent of the source VDisk can again be regarded as partitioned into logical subextents. Each subextent corresponds to a RAID, which might be implemented at any RAID level as described herein. The target VDisk will be organized similarly. The type of RAID and the number of physical drives involved in implementing the target VDisk might be the same as the source, or might be different.

In some embodiments of interleaved copying using the Intermediate approach, the extent of a source VDisk can again be regarded as partitioned into natural subextents, where each subextent corresponds to an internal VDisk. Each internal VDisk itself might have any configuration, and, in particular, might be the concatenation of yet other internal VDisks having any configuration. Ultimately, each subextent will involve storage on one or more PDisks. The relationship between the subextent VDisks and their physical implementation might be any hierarchical combination of RAIDs, but might also involve any non-RAID virtualization techniques such as concatenation. The target VDisk will be organized similarly, and has the same degree of flexibility in its virtualization configuration. The virtualization configuration and the number of physical drives involved in implementing the target VDisk might be the same as the source, or might be different.

In another embodiment of the Intermediate Approach, consider a copy situation in which the data is striped on PDisks implementing either the source VDisk, the target VDisk, or both of them. In general, if only the source VDisk is configured by striping across PDisks, or if the target VDisk is to be implemented by striping that is identical in size and number of PDisks to the virtualization configuration of the source VDisk (striping over the same number of PDisks with the same stripe size), there is an advantage to having the chunk size evenly divide the stripe size corresponding to the source. If only the target VDisk is configured by striping across PDisks, there is an advantage if the chunk size evenly divides the stripe size corresponding to the target. If both the source VDisk and the target VDisk are configured by striping across PDisks, there is an advantage if the chunk size evenly divides both the stripe sizes corresponding to the source and target VDisks, respectively. If such a mutually compatible chunk size does not exist in a striping consideration, the copy will ordinarily be handled with the Advanced Approach.

In general, the virtualization configurations of the first and second VDisks in a binary bulk IO operation can be quite dissimilar. Some information will typically be conveyed to coordinating logic about one or both of the VDisks. Coordination may be handled by the source controller or the target controller (if any). Two or more controllers may cooperate or exchange information. Interleaved bulk copying may involve joint consideration of factors affecting performance within the two virtualization configurations, such as finding a common chunk size that is advantageous for both source and target.

In the Advanced Approach, a controller, typically the controller of the source VDisk, will manage the bulk copy operation. Coordinating logic might take into account in interleaved copying any or all of the factors already mentioned with respect to unary VDisk bulk IO operations (e.g., read or write. These factors might be considered singly or jointly. For example, even if load on a particular source PDisk or VDisk containing a particular chunk of data is light, the load on a corresponding target PDisk or VDisk (e.g., in a copy operation, a storage device to which the chunk will be copied) might be heavy.

As with a unary bulk IO operations, taking into account some or all of these factors, the controller 105 can apply logic to decide when to process a chunk 800 of data, what the boundaries of the chunk 800 should be, how to manage tasks 1220, and which storage devices to use in the process. For example, a decision may be made, for example, about which copy from a plurality of mirroring storage devices (whether VDisks 125 or PDisks 120) to use in the bulk IO operation. In this case, however, the decision-making logic might consider the source VDisk 1200 individually, the target VDisk 1201 individually, or the source VDisk 1200 and target VDisk 1201 in combination. The same kinds of statistical and forecasting techniques described above in connection with unary bulk IO operations can be applied to the decision-making logic for binary bulk IO operations.

Note that mixed approaches are also possible within the scope of the invention. For example, the basic approach might be used to read a source VDisk, but the advanced approach might be used for the target VDisk. A rebuild operation may be a binary operation in which the target disk is a physical disk, but the source might be a VDisk. In this case, any of the three approaches might be used on the source, with a modified form of the Basic Approach (i.e., the target is a PDisk) used on the target.

### BRIEF DESCRIPTION OF THE DRAWINGS

FIG. 1 is a block diagram illustrating a storage system in an embodiment of the invention.

FIG. 2 is a tree diagram illustrating a hierarchical implementation of a virtual disk, showing storage system capacities at the various levels of the tree, in an embodiment of the invention.

FIG. 3 is a block diagram illustrating striping of data across physical disks in an embodiment of the invention.

FIG. 4 is a tree diagram illustrating how a hierarchical implementation of a virtual disk might be configured with all internal storage nodes being abstract.

FIG. 5 is a tree diagram illustrating how a hierarchical implementation of a virtual disk might be configured with all internal storage nodes being virtual disks.

FIG. 6 is a flowchart showing a basic approach for parallelization of a bulk IO operation in an embodiment of the invention.

FIG. 7 is a flowchart showing an intermediate approach for parallelization of a bulk IO operation in an embodiment of the invention.

FIG. 8 is a block diagram showing, in an embodiment of the invention, a partitioning of an extent of a top level VDisk into subextents, each subextent corresponding to a RAID in the virtualization configuration.

FIG. 9 is a block diagram showing, in an embodiment of the invention, a partitioning of an extent of a top level VDisk into subextents, each subextent corresponding to an internal VDisk in the virtualization configuration.

FIG. 10 is a block diagram showing, in an embodiment of the invention, a partitioning of an extent of a top level VDisk into subextents, each subextent corresponding to a set of stripes in the virtualization configuration.

FIG. 11 is a flowchart showing an advanced approach for parallelization of a bulk IO operation in an embodiment of the invention.

FIG. 12 is a block diagram illustrating the structure of two virtual disks in a basic approach for a parallel bulk copy operation.

FIG. 13 is a flowchart showing a basic approach for parallelization of a bulk copy operation in an embodiment of the invention.

FIG. 14 is a flowchart showing an intermediate approach for parallelization of a bulk copy operation in an embodiment of the invention.

FIG. 15 is a block diagram illustrating an embodiment of the invention using interleaving to copy a source virtual disk to a target virtual disk, where both virtual disks are implemented as RAIDs that utilize a plurality of physical disks.

FIG. 16 is a block diagram illustrating an embodiment of the invention using interleaving to copy a source virtual disk to a target virtual disk, where both virtual disks are implemented as internal VDisks that utilize a plurality of physical disks.

FIG. 17 is a block diagram illustrating an embodiment of the invention using interleaving to copy a source virtual disk to a target virtual disk, where both virtual disks are implemented as stripes across a plurality of physical disks.

FIG. 18 is a flowchart showing an advanced process for parallelization of a bulk copy operation in an embodiment of the invention.

### DETAILED DESCRIPTION OF THE INVENTION

The specific embodiments of this Description are illustrative of the invention, but do not represent the full scope or applicability of the inventive concept. For the sake of clarity, the examples are greatly simplified. Persons of ordinary skill in the art will recognize many generalizations and variations of these embodiments that incorporate the inventive concept.

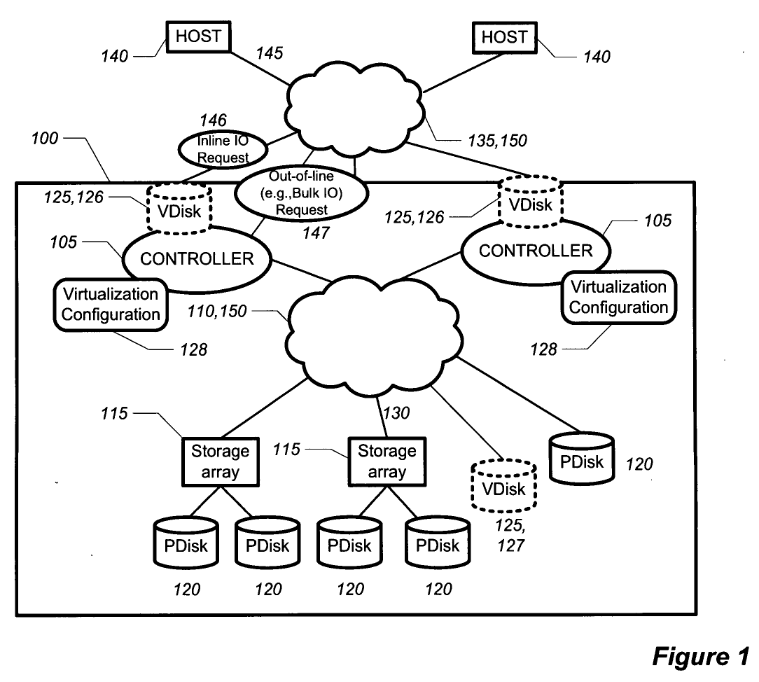

An exemplary storage system 100 illustrating ideas relevant to the invention is shown in FIG. 1. The storage system 100 may contain one or more controllers 105. Each controller 105 accesses one or more PDisks 120 and/or VDisks 125 for read and write operations. Although VDisks 125 are ultimately implemented as PDisks 120, a controller 105 may or may not have access to details of that implementation. As illustrated in the figure, PDisks 120 may or may not be aggregated into storage arrays 115. The storage system 100 communicates internally using a storage system communication system 110 to which the storage arrays 115, the PDisks 120, and the controllers 105 are connected. Typically, the storage system communication system 110 is implemented by one or more networks 150 and/or buses, usually combining to form a storage area network (SAN). Connections to the storage system communication system 110 are represented by solid lines, typified by one labeled 130.

Each controller 105 may make one or more VDisks 125 available for access by hosts 140 external to the storage system 100 across an external communication system 135, also typically implemented by one or more networks 150 and/or buses. We will refer to such VDisks 125 as top level VDisks 126. A host 140 is a system, often a server, which runs application software that sometimes requires input/output operations (IO), such as reads or writes, to be performed on the storage system 100. A typical application run by a host 140 is a database management system, where the database is stored in the storage system 100. Client computers (not shown) often access server hosts 140 for data and services, typically across a network 150. Sometimes one or more additional layers of computer hardware exist between client computers and hosts 140 that are data servers in an n-tier architecture; for example, a client might access an application server that, in turn, accesses one or more data server hosts 140.

Connections to the external communication system 135 are represented by solid lines, typified by one labeled 145. A network 150 utilized in the storage system communication system 110 or the external communication system 135 might be a local area network (LAN), a wide area network (WAN), or a personal area network (PAN). It might be wired or wireless. Networking technologies might include Fibre Channel, SCSI, IP, TCP/IP, switches, hubs, nodes, and/or some other technology, or a combination of technologies. In some embodiments the storage system communication system 110 and the external communication system 135 are a single common communication system, but more typically they are separate.

A controller 105 is essentially logic (which might be implemented by one or more processors, memory, instructions, software, and/or storage) that may perform one or more of the following functions to manage the storage system 100: (1) monitoring events on the storage system 100; (2) responding to user requests to modify the storage system 100; (3) responding to requests, often from the external hosts 140 to access devices in the storage system 100 for IO operations; (4) presenting one or more top level VDisks 126 to the external communication system 135 for access by hosts 140 for IO operations; (5) implementing a virtualization configuration 128 for a VDisk 125; and (6) maintaining the storage system 100, which might include, for example, automatically configuring the storage system to conform with specifications, dynamically updating the storage system, and making changes to the virtualization configuration 128 for a VDisk 125 or its implementation. The logic may be contained in a single device, or it might be dispersed among several devices, which may or may not be called “controller.”

The figure shows two different kinds of VDisks 125, top level VDisks 126 and internal VDisks 127. A top level VDisk 126 is one that is presented by a controller 105 for external devices, such as hosts 140, to request IO operations using standard PDisk 120 commands through an in-line request 146 to its virtual facade. It is possible for a controller 105 to accept an out-of-line request 147 that bypasses the virtual facade. Such an out-of-line request 147 might be to perform a bulk IO operation, such as a write to the entire extent of the top level VDisk 126. Behaving similarly to a host 140 acting through the facade, a controller 105 may also make a request to a VDisk 125 (either top level or internal), or it might directly access PDisks 120 and VDisks 125 within the virtualization of the top level VDisk 126. An internal VDisk 127 is a VDisk 125 that is used within the storage system 100 to implement a top level VDisk 126. The controller 105 may or may not have means whereby it can obtain information about the virtualization configuration 128 of the internal VDisk 127.

A virtualization configuration 128 (or VDisk configuration 128) maps the extent of a VDisk 125 to storage devices in the storage system 100, such as PDisks 120 and VDisks 125. FIG. 1 does not give details of such a mapping, which are covered by subsequent figures. Two controllers 105 within the same storage system 100 or different storage systems 100 can share information about virtualization configurations 128 of their respective VDisks 125 by communications systems such as the kinds already described.

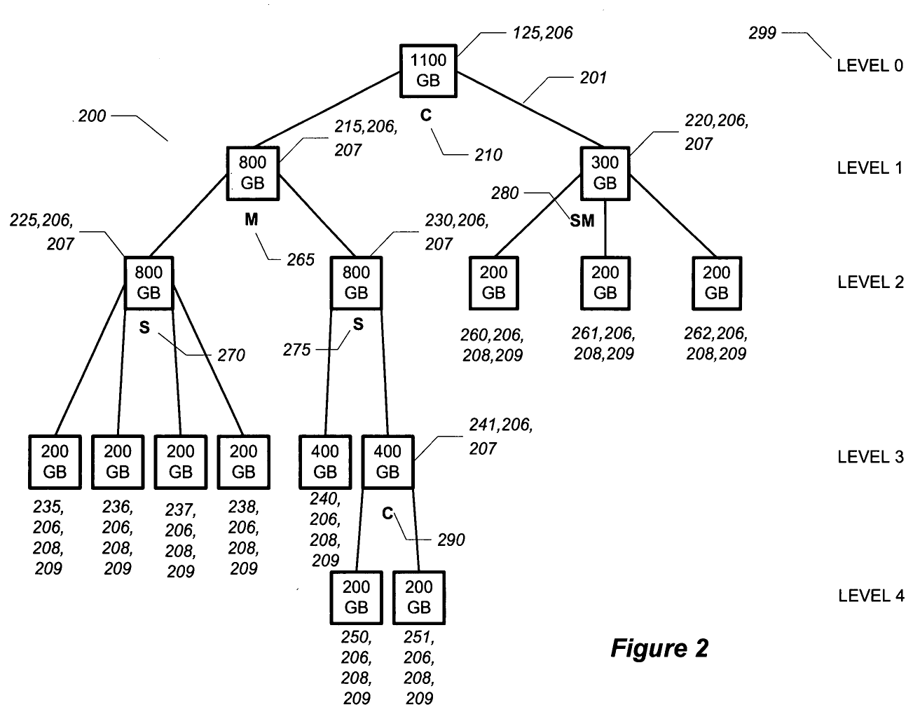

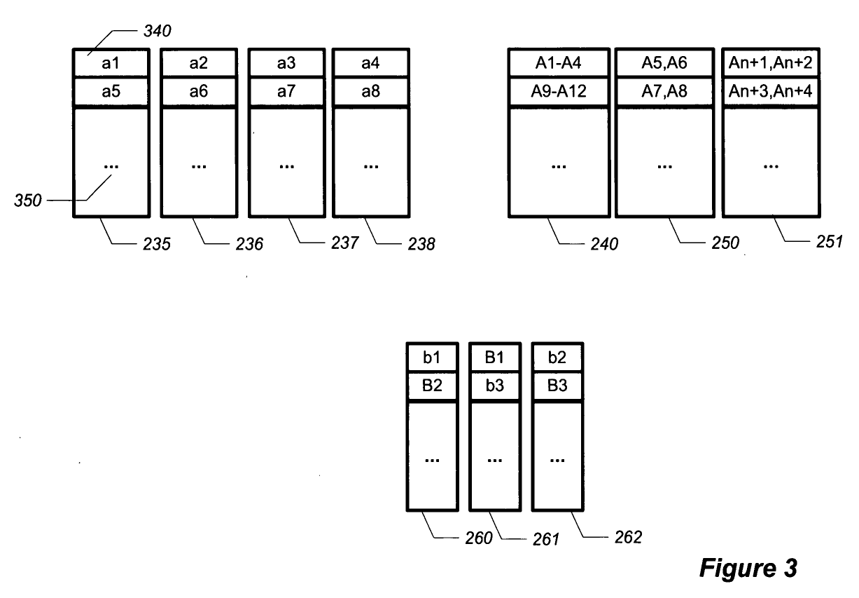

FIGS. 2 through 4 relate to aspects and variations of an example used to illustrate various aspects and embodiments of the invention. FIG. 2 shows some features of a virtualization configuration 128 in the form of a virtualization tree 200 diagram. This virtualization configuration 128 was not chosen for its realism, but rather to illustrate some ideas that are important to the invention. The top level VDisk 126, which is the VDisk 125 to which the virtualization configuration 128 pertains and upon which a bulk IO operation is to be executed, has a size, or capacity, of 1,100 GB. The tree has five levels 299, a representative one of which is tagged with a reference number, labeled at the right of the diagram as levels 0 through 4. “Higher” levels 299 of the tree have smaller level numbers, so level 0 is the highest level 299 and level 4 is the lowest. The tree has sixteen nodes 206, each node 206 represented by a box with a size in GB. Some nodes 206 have subnodes (i.e., child nodes); for example, nodes 215 and 220 are subnodes of the top level VDisk 126. Association between a node 206 and its subnodes, if any, is indicated by branch 201 lines, typified by the one (designated with a reference number) between the top level VDisk 126 and node 220. Those nodes 206, including node 235, which have no subnodes are termed leaf nodes 208. The leaf nodes 208 represent actual physical storage devices (PDisks 120), such as rotational media drive, solid state drives, or tape drives. Those nodes 206 other than the top level VDisk 126 that are not leaf nodes 208 are internal nodes 207, of which there are five in the figure; namely, nodes 215, 225, 230, 220, and 241. By summing up the sizes of the ten PDisks 120 in the virtual configuration of the top level VDisk 126, it can be seen that its 1,100 GB virtual size actually utilizes 2,200 GB of physical storage media. The arrangement of data on the ten PDisks 120 will be detailed below in relation to FIG. 3.

The association between a given node 206 and its subnodes arises from, in this example, one of four relationships shown in the figure, either concatenate (‘C’), mirror (‘M’), stripe (‘S’), or a combination of stripe and mirror (‘SM’). For example, the top level VDisk 126 is a concatenation 210 of nodes 215 and 220. Node 215 represents the mirror relationship 265 implemented by nodes 225 and 230. Node 225 represents the striping relationship 270 across PDisks 235 through 238. Node 230 represents the striping relationship 275 across nodes 240 (a leaf node) and 241. Node 241 represents the concatenation relationship 290 of PDisks 250 and 251. Node 220 represents the combination 280 of a striping relationship and a two-way mirroring relationship, where the striping is done across three physical storage devices 260 through 262.

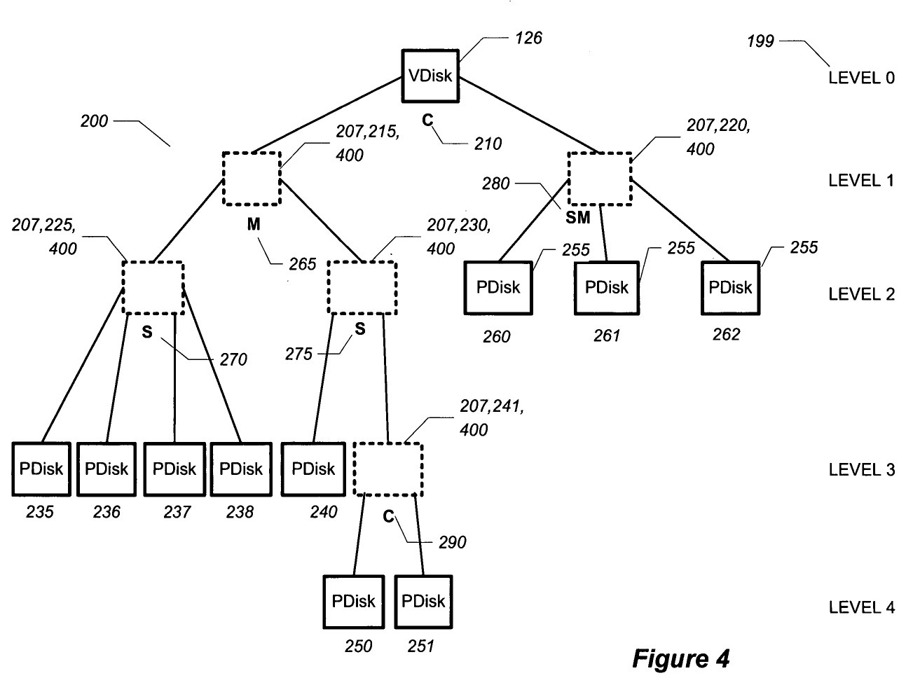

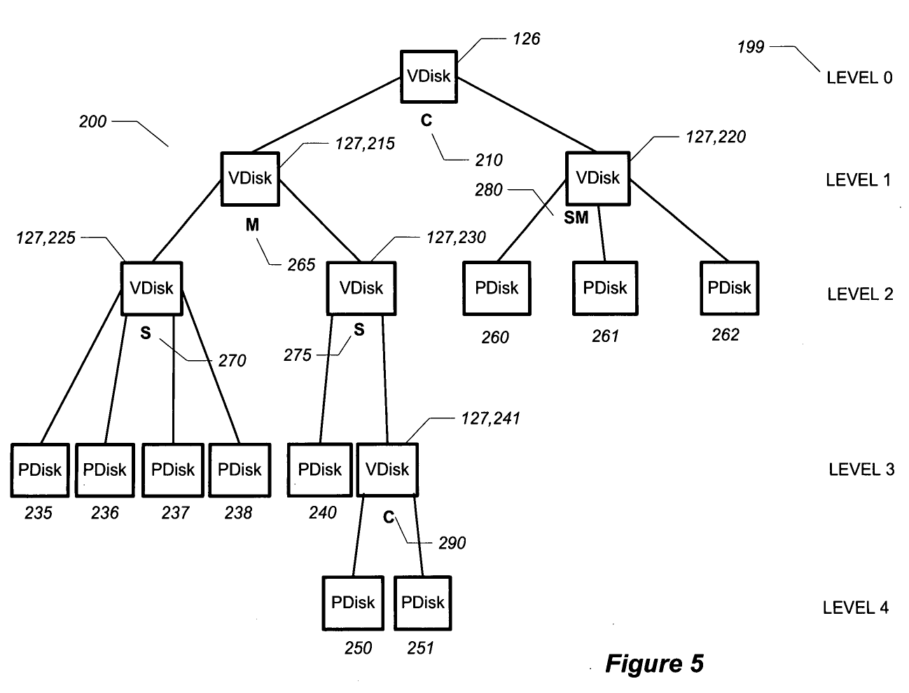

In FIG. 2, only the leaf nodes 208 of the tree (namely, the ten nodes 235-238, 250, 251, and 260 through 262) represent PDisks 120. The internal nodes 207 represent particular subextents of the top level VDisk 126 that stand in various relationships with their subnodes, such as mirroring, striping, or concatenation. Two possibilities for how these internal nodes 207 might be implemented in practice will be discussed below in connection with FIG. 4 and FIG. 5.

FIG. 3 shows an example of how data might be arranged in stripes 340 (one characteristic stripe 340 is labeled with a reference number in the figure) on the ten PDisks 120 shown in FIG. 2. The arrangement of data and corresponding notation of PDisk 235 is illustrative of all the PDisks 120 shown in this figure. A stripe 340 on PDisk 235 contains data designated al. Here, the letter ‘a’ represents some subextent 800, or chunk 800, of data, and the numeral ‘1’ represents the first stripe of that data. As shown in the figure, dataset a is striped across the four PDisks 235 through 238. Extents a1 through a8 are shown explicitly in the figure. PDisk 235 includes extents a1 and a5, and potentially other extents, such as a9 and a13, as indicated by the ellipsis 350.

Extent a1 (which represents a subextent of the top level VDisk 126) is mirrored by extent A1, which is found on PDisk 240. In general, in the two character designations for extents, lower and upper case letters with the same stripe number are a mirror pair. Extents b3 on PDisk 261 and B3 on PDisk 262 are another example of a data mirror pair. In the case of b3 and B3, the content of the extents are the same as the contents of the corresponding stripes. Labeled extents, such as A1, that are shown on PDisks 240, 250, and 251 (unlike the other PDisks 120 shown in the figure) do not occupy a full stripe. For example, the first stripe 340 on PDisk 240 contains extents A1 through A4.

The first extent of the first stripe 340 on PDisk 251 is An+1, where ‘n’ is an integer. This implies that the last extent of the last stripe 340 on PDisk 250 is An. The last extent on PDisk 250 will be A2n, since PDisks 250 and 251 have the same capacities.

Distribution of stripes resulting from the relationship 280 is illustrated by PDisks 260 through 262. Mirrored extents occupy stripes 340 that are consecutive, where “consecutive” is defined cyclically. For example, extent b2 occupies a stripe 340 (in the first strip) on PDisk 262, with the next consecutive stripe being B2 on PDisk 260.

A top level VDisk 126 emulates the behavior of a single PDisk. FIGS. 2 and 3 only begin to suggest how complex the virtualization configuration 128 of a top level VDisk 126 might conceivably be. In principle, there are no limits to the number of levels 299 and nodes 206 in a virtualization tree 200, and the relationships can sometimes be complicated. While on one hand, the purpose of virtualization is to hide all this complexity from the hosts 140 and from users, a controller 105 that is aware that a bulk IO operation is requested can exploit details of the virtualization configuration 128 to improve performance automatically.

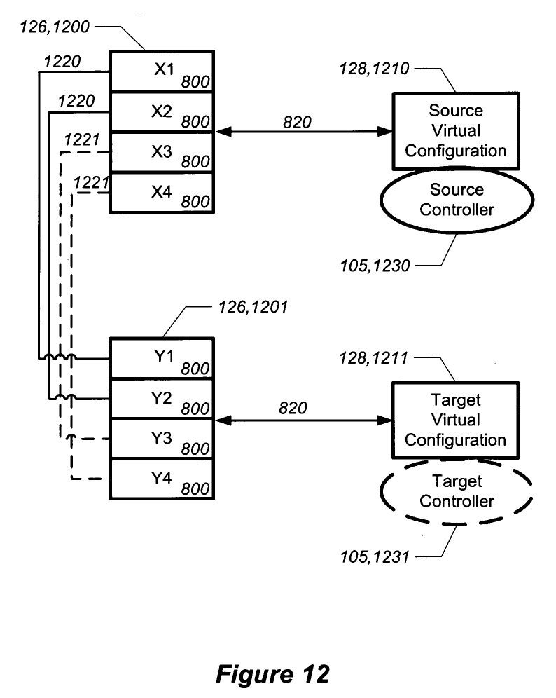

A key concept of the invention is to employ multiple tasks 1220 (see FIG. 12) running in parallel to jointly perform a bulk IO operation on one or more top level VDisk 126. The tasks 1220 might be implemented as requests sent by the controller to be executed by storage devices; or they might execute within threads running in parallel, or any other mechanism facilitating processes running in parallel. A thread is a task 1220 that runs essentially simultaneously with other threads that are active at the same time. We regard separate processes at the operating system level as separate threads for purposes of this document. Threads can also be created within a process, and run pseudo-simultaneously by means of time-division multiplexing. Threads might run under the control of a single processor, or different threads might be assigned to distinct processors. A task 1220 can be initiated by a single thread or multiple threads.

The most straightforward way to perform a read or write operation using some or all of the extent of the top level VDisk 126 is to iterate sequentially through the extent in a single thread of execution. Suppose, for example that an application program running on a host needs to set the full extent of the top level VDisk 126 to zero, and suppose that the storage unit of the top level VDisk 126 is a byte. In principle, the application could loop through the extent sequentially, setting each byte to zero. In the extreme, each byte written could generate a separate write operation on each PDisk to which that byte is mapped by the virtualization tree. In practice, however, a number of consecutive writes will often be accumulated into a single write operation. Such accumulation might be done by the operating system level, a device driver, or a controller 105 of the storage system 100.

The present invention recognizes that significant improvements in performance can be achieved in reading from or writing to an extent of the top level VDisk 126 by splitting the extent into subextents 800, assigning subextents 800 to tasks 1220, and running the tasks 1220 in parallel. How much improvement is achieved depends on the relationship between the extents chosen and their arrangements on the disk. Among the factors that affect the degree of improvement are: contention due to the bulk IO operation itself; contention due to operations external to the operation; the speed of individual components of the virtualization configuration, such as PDisks; and the dependence of transfer rate of the storage system communication system 110 upon the volume of data in a single data transfer. Each of these performance factors will be discussed in more detail below.

Two tasks 1220 might attempt to access the same storage device at the same time. Some modern storage devices such as solid state drives (SSDs) allow this to happen without contention. But conventional rotational media devices (RMDs) and tape drives can perform only one read or write operation at a time. In FIG. 3, consider, for example, the situation in which a first task 1220 is reading stripe 340 a1, when a second task 1220 is assigned stripe 340 a5, both of which are on PDisk 235. In this case, the second task 1220 will need to sit idle until the first completes. Consequently, the invention includes logic, in the controller 105 for example, to minimize this kind of contention.

Logic may also be included to avoid contention of the storage devices with processes accessing those devices other than the bulk IO operation in question. Statistics over an interval of time leading up to a time of decision-making (e.g., one second) that relate to load on the storage devices can be measured and taken into account by the logic. The logic can also consider historically observed patterns in predicting load. For example, a particular storage device might be used at a specific time daily for a routine operation, such as a backup or a balancing of books. Another situation that might predict load is when a specific sequence of operations is observed involving one or more storage devices. Note that the logic might be informed of upcoming load by hosts 140 that access the storage system 100. A more flexible storage system 100, however, will include logic using statistical techniques well known in the art to make forecasts of load based upon observations of historical storage system 100 usage.

A third factor considered by the logic in improving efficiency is dependency of transfer rate of the storage system communication system 110 on the amount of data in a given transfer. In an extreme case, consider having several tasks 1220, each assigned to transfer a single storage unit (e.g., byte) of data. Because each transfer involves time overhead in terms of both starting and stopping activities and data overhead in terms of header and trailer information used in packaging the data being transferred into some kind of packet, single storage unit transfers would be highly inefficient. On the other hand, a given PDisk 120 might have a limit on how much data can be transferred in a single chunk 800. If the chunk 800 size is too large, time and effort will wasted on splitting the chunk 800 into smaller pieces to accommodate the technology, and subsequently recombining the pieces.

Contention and delay due to inappropriate packet sizing can arise from PDisks 120 anywhere in the virtualization tree 200 hierarchy representing the virtualization configuration 128. An important aspect of the invention is having a central point in the tree hierarchy where information relating to the performance factors is assembled, analyzed, and acted upon in assigning chunks 800 of data on particular storage devices to threads for reading or writing. Ordinarily, this role will be taken by a controller 105 associated with the level of the top level VDisk 126. If two controllers 105 are involved, then one of them will need to share information with the other. How information is accumulated at that central location will depend upon how the virtualization tree is implemented, as will now be discussed.

FIGS. 4 and 5 present two possible ways that control of the virtualization tree 200 of FIG. 2 might be implemented. In FIG. 4, all the internal nodes 207 are mere abstractions in the virtualization configuration 128. The PDisks 120 under those abstract nodes 400 in the virtualization tree 200 are within the control of the controller 105 for the top level VDisk 126. Under this configuration, the controller 105 might have information about all levels 299 in the virtualization tree 200.

In FIG. 5, each internal node 207 of the tree is a separate VDisk 125 that is controlled independently of the others. In addition to the top level VDisk 126, each internal node 207, such as the one labeled internal VDisk 127, is a VDisk 125. Without the invention, writing the full extent of the top level VDisk 126 might entail the controller 105 simply writing to VDisks at nodes 215 and 220. Writing to lower levels in the tree would be handled by the internal VDisks 127, invisibly to the controller 105. Similarly, without the invention, reading the full extent of the top level VDisk 126 would ordinarily entail simply reading from VDisks at nodes 215 and 220. Reading from lower levels in the tree would be handled by the nested VDisks, invisibly to the top level VDisk 126. It is important to note that FIGS. 4 and 5 represent two “pure” extremes in how the top level VDisk 126 might be implemented. Mixed configurations, in which some internal nodes 207 are abstract and others are internal VDisks 127 are possible, and are covered by the scope of the invention.

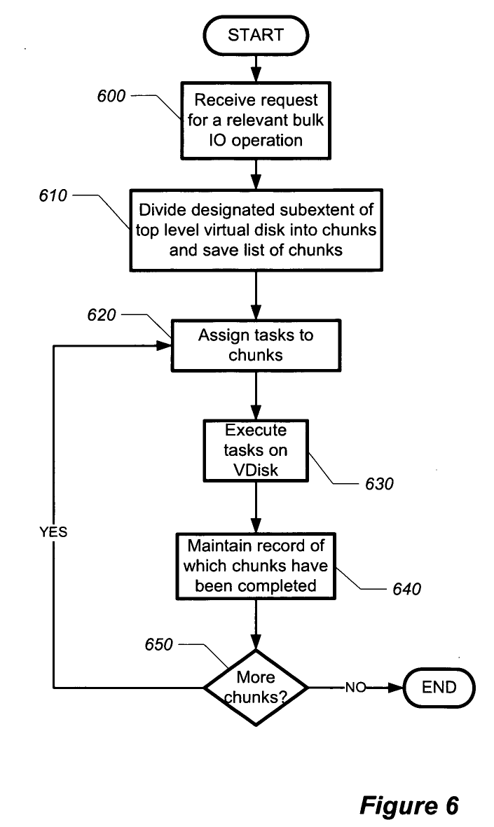

A central concept of the invention is to improve the performance of 10 operations accessing the top level VDisk 126 by parallelization, with varying degrees of intelligence. More sophisticated forms of parallelization, take into account factors affecting performance; examples of such factors include information relating to hardware components of the virtualization configuration; avoidance of contention by the parallel threads of execution; consideration of external load on the storage devices; and performance characteristics relating to the transmission of data. In order to do such parallelization of a bulk IO operation, the central logic, e.g., a controller 105 of the top level VDisk 126, must be aware that the operation being performed is one which such parallelization is possible (e.g., an operation to read from, or to write to, an extent of the top level VDisk 126) and in which the order of completion of various portions of the operation is unimportant. Embodiments of three approaches of varying degrees of sophistication—Basic, Intermediate, and Advanced—will be shown in FIGS. 6 through 11 for a unary bulk IO operation such as a read or a write.

FIG. 6 is a flowchart showing a basic approach for parallelization of a bulk IO operation in an embodiment of the invention. In step 600 of the flowchart of FIG. 6, a request is received by the controller 105 for the top level VDisk 126 to perform a bulk IO operation. It is important to note that the controller 105 be aware of the nature of the operation that is needed. If an external host 140 simply accesses the top level VDisk 126 through the standard interface, treating the top level VDisk 126 as a PDisk 120, then the controller 105 will not be aware that it can perform the parallelization. Somehow, the controller 105 must be informed of the operation being performed. This might happen through an out-of-line request 147 from a host 140, whereby the host 140 directly communicates to the controller 105 that it wants to perform a read or write accessing an extent of the top level VDisk 126. Some protocol must be in existence for a write operation to provide the controller 105 with the data to be written; and, for a read operation, so that the controller 105 can provide the data to the host 140. The protocol will typically also convey the extent of the top level VDisk 126 to be read or written to.

For operations internal to the storage system 100, the controller 105 might already be aware that a bulk IO operation will be performed, and, indeed, the controller 105 might itself be triggering the operation either automatically or in response to a user request. One example is the case of an initialization of one or more partitions, virtual or physical drives, or storage arrays 115, a process that might be initiated by the controller 105 or other logic within the storage system 100 itself. Defragmentation or scrubbing operations are other examples of bulk IO operations that might also be initiated internally within the storage system 100.

In step 610 of FIG. 6, an extent of the top level VDisk 126 designated to participate in the read or write operation (which might be the entire extent of the top level VDisk 126) is partitioned into further subextents 800. The chunks 800 are listed and the list is saved digitally (as will also be the case for analogous steps in subsequent flowcharts). It might be saved in any kind of storage medium, for example, memory or disk. Saving the list allows the chunks 800 to be essentially checked off as work affecting a chunk 800 is completed. Examples of the types of information that might be saved about a chunk 800 are its starting location, its length, and its ending location. Tasks are assigned to some or all of the chunks 800 in step 620. In some cases, the tasks 1220 will be run in separate threads. Threads allow tasks 1220 to be executed in parallel, or, through time slicing, essentially in parallel. Each thread is typically assigned to a single chunk 800. In step 630, tasks 1220 are executed, each performing a read or a write operation for the chunk 800 associated with that task 1220. When a task 1220 completes, in some embodiments a record is maintained 640 in some digital form to reflect that fact. In effect, the list of chunks 800 would be updated to show the ones remaining. Of course, the importance of this step is diminished or eliminated if all the chunks 800 are immediately assigned to separate tasks 1220, although ordinarily it will still be important for the logic to determine when the last task 1220 has completed. If 650 more chunks 800 remain, then tasks 1220 are assigned to some or all of them and the process continues. Otherwise, the process ends.

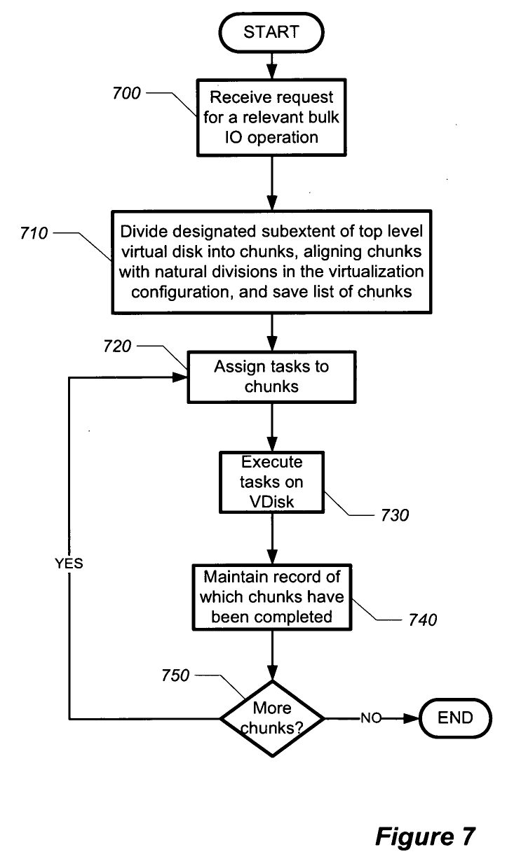

The Basic Approach of FIG. 6 will in most cases reduce the total time for the read or write operation being performed, but it ignores the structure of the virtualization configuration 128—e.g., as illustrated by FIGS. 2 through 4. The Intermediate Approach, an embodiment of which is shown in FIG. 7, utilizes that structure more effectively in certain special cases. With the exception of step 710, steps 700 through 750 are identical to their correspondingly numbered counterparts in FIG. 6 (e.g., step 700 is the same as 600); discussion of steps in common will not be repeated here. Step 710 is different from 610 in that the partition of the extent of the top level VDisk 126 results in alignment of the chunks 800 with some “natural” division in the virtualization configuration 128, examples of which are given below.

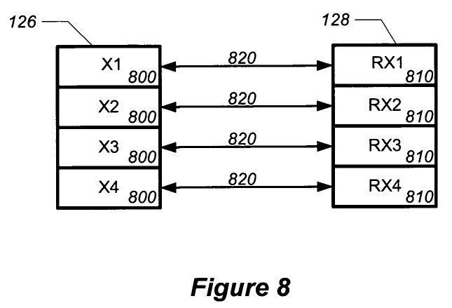

For example, as in FIG. 8, the extent of the top level VDisk 126 might be a concatenation of, say, four RAIDs 810. (Here, as elsewhere in this Description, numbers like “four” are merely chosen for convenience of illustration, and might have any reasonable value.) It is this natural division of the extent into RAIDs 810 that qualifies this configuration for the Intermediate Approach. Each subextent 800 of the top level VDisk 126 that is mapped 820 by the virtualization configuration 128 to a RAID 810 might be handled as a chunk 800. The chunks 800 might have the same size of different sizes. The portion of the bulk IO operation corresponding to a given chunk 800 would be executed in a separate task 1220, with at least two tasks 1220 running at some point during the execution process. In some embodiments, when one task 1220 completes another is begun until all chunks 800 have been processed. In some embodiments, the chunks 800 are processed generally in their order of appearance within the top level VDisk 126, but in others a nonconsecutive ordering of execution may be used.

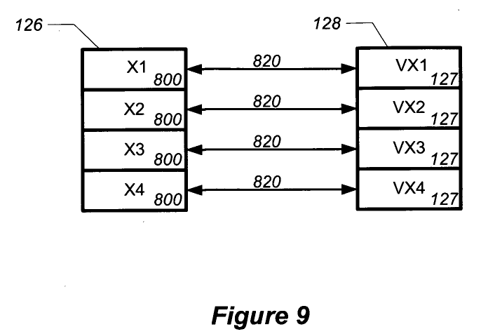

In another example (FIG. 9) of a natural partition that can be handled with the Intermediate Approach, the extent of the top level VDisk 126 might be a concatenation of, say, four internal VDisks 127. It is this natural division of the extent into internal VDisks 127 that qualifies this configuration for the Intermediate Approach. Each subextent 800 of the top level VDisk 126 that is mapped 820 by the virtualization configuration 128 to a internal VDisk 127 might be handled as a chunk 800. The chunks 800 might have the same size of different sizes. The portion of the bulk IO operation corresponding to a given chunk 800 would be executed in a separate task 1220, with at least two tasks 1220 running at some point during the execution process. In some embodiments, when one task 1220 completes another is begun until all chunks 800 have been processed. In some embodiments, the chunks 800 are processed generally in their order of appearance within the top level VDisk 126, but in others a nonconsecutive ordering of execution may be used.

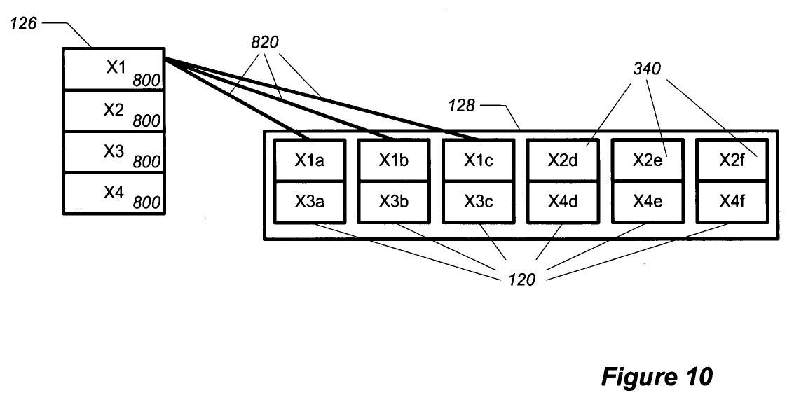

In a third example (FIG. 10) of a natural partition that can be handled with the Intermediate Approach, the extent of the top level VDisk 126 might be a concatenation of, say, four subextents 800. Each subextent 800 of the top level VDisk 126 that is mapped 820 by the virtualization configuration 128 to a set of stripes 340 (typified by those shown in the figure with a reference number) across a plurality of PDisks 120 might be handled as a chunk 800. It is this natural division of the extent into stripes 340 that qualifies this configuration for the Intermediate Approach. In the figure, the subextent labeled X1 is mapped 820 by the virtualization configuration 128 to three stripes 340 distributed across three PDisks 120. The other subextents 800 are similarly mapped 820, although the mapping is not shown explicitly in the figure. The portion of the bulk IO operation corresponding to a given chunk 800 would be executed in a separate task 1220, with at least two tasks 1220 running at some point during the execution process. In some embodiments, when one task 1220 completes another is begun until all chunks 800 have been processed. In some embodiments, the chunks 800 are processed in their order of appearance within the top level VDisk 126, but in others a nonconsecutive ordering of execution may be used.

In executing a task using the Intermediate Approach, the controller might utilize the virtualization interface of the top level VDisk 126. If so, the controller would be behaving as if it were an external host. On the other hand, the controller might directly access the implementation of the virtualization configuration of the top level VDisk. For example, in the case of concatenated internal VDisks, tasks generated by the controller might invoke the internal VDisks through their respective virtualization interfaces.

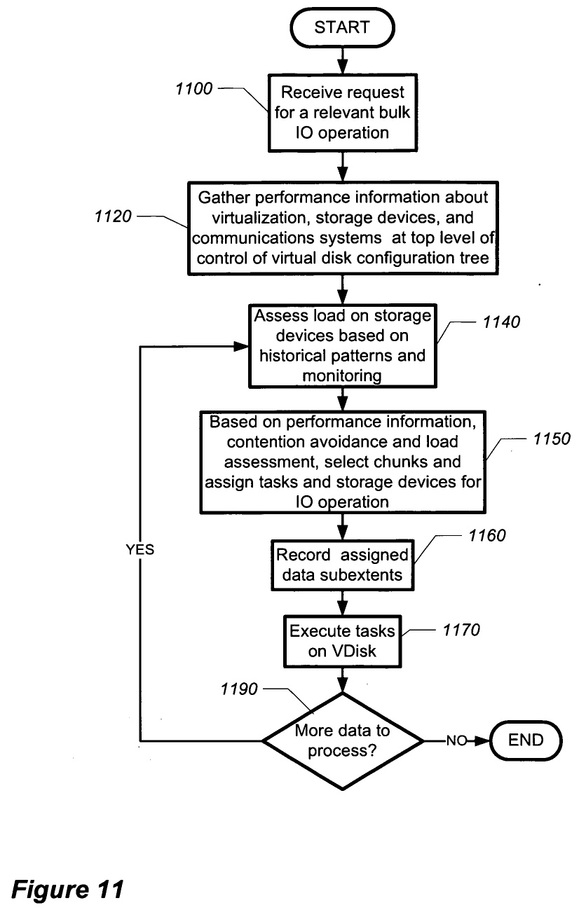

FIG. 11 is an embodiment of the Advanced Approach invention, which takes into account various factors, discussed herein previously, to improve the performance that can be achieved with parallel processing. In step 1100, a request is received by the controller for the top level VDisk 126 to perform a relevant IO operation. The same considerations apply as in previously discussed embodiments requiring awareness by the controller 105 of the nature of the bulk IO operation that is being requested.

In step 1120, information is obtained about the virtualization configuration tree. The relevant controller 105 might have gather the information to obtain it, unless it already has convenient access to such information, for example, in a configuration database in memory or storage. This might be true, e.g., in the virtualization configuration 128 depicted in FIG. 4, where internal nodes are abstract and the top level controller manages how IO operations are allocated to the respective PDisks 120.

Information available to the controller 105 may be significantly more limited, however, in some circumstances. For example, in FIG. 5, the controller 105 may not be aware that node 215 is implemented using the mirroring relationship 265 or that node 220 is implemented using the combined striping-mirroring relationship 280. Lower levels 299 in the virtualization tree 200, including the implementations of internal VDisks 225, 230, and 241 may also be invisible to the controller 105 due to the virtualization facades of the various VDisks 125 involved at those levels 299 of the virtualization tree 200.

How much information can be obtained from a given internal VDisk 127 by a controller 105 depends upon details of the implementation of the internal VDisk 127 and upon the aggressiveness of the storage system 100 in monitoring and exploiting facts about its historical performance. The simplest possibility is that the virtualization configuration 128 (and associated implementation) of the internal VDisk 127 is entirely opaque to higher levels 299 in the virtualization tree 200. In this case, some information about the performance characteristics of the node 206 may still be obtained by monitoring the node 206 under various conditions and accumulating statistics. Statistical models can be developed using techniques well-known in the art of modeling and forecasting to predict how the internal VDisk 127 will perform under various conditions, and those predictions can be used in choosing which particular PDisks 120 or VDisks 125 will be assigned to tasks 1220.

Another possibility is that an internal VDisk 127 might support an out-of-line request 147 for information about its implementation and performance. The controller 105 could transmit such an out-of-line request 147 to internal VDisks 127 to which it has access. Moreover, such a request for information might be implemented recursively, so that the (internal) controller 105 of the internal VDisk 127 would in turn send a similar request to other internal VDisks 127 below it in the tree. Using such recursion, the controller 105 might conceivably gather much or all of the information about configuration and performance at the lower levels 299 of the virtualization tree 200. If this information is known in advance to be static, the recursion would only need to be done once. However, because generally a virtualization configuration 128 will change from time to time, the recursion might be performed at the start of each bulk IO operation, or possibly even before assignment of an individual task 1220.

A third possibility is that an internal VDisk 127 might support an out-of-line request 147 request to handle a portion of the overall bulk IO operation that has been assigned to that node 206 in a manner that takes into account PDisks 120 and/or VDisks 125 below it in the tree, with or without reporting configuration and performance information to the higher levels 299. In effect, a higher level VDisk 125 would be delegating a portion of its responsibilities to the lower level internal VDisk 127. In practice, a virtualization configuration 128 for the top level VDisk 126 may include any mixture of abstract nodes 400 and internal VDisks 127, where upon request some or all of the internal VDisks 127 may be able to report information from lower levels of the configuration tree, choose which inferior (i.e., lower in the tree) internal VDisks 127 or PDisks 120 will be accessed at a given point within an IO operation, or pass requests recursively to inferior internal VDisks 127.

Any information known about the virtualization configuration 128 can be taken into account by the controller 105 or any internal VDisks 127 involving its inferior PDisks 120 and internal VDisks 127 in the bulk IO operation at certain times. For example, one copy in a mirror relationship might be stored on a device faster than the other for the particular operation (e.g., reading or writing). The logic might select the faster device. The storage system communication system 110, software and/or hardware, employed within the storage system 100 may transfer data in certain aggregate sizes more efficiently than others. The storage devices may be impacted by external load from processes other than the bulk IO operation in question, so performance will improve by assigning tasks 1220 to devices that are relatively less loaded. In addition to load from external processes, the tasks 1220 used for the bulk IO operation itself can impact each other. Having multiple requests queued up waiting for a particular storage device (e.g., a rotational media hard drive) when other devices are not doing anything makes no sense.

The invention does not require that such information known by the controller 105 about the virtualization configuration and associated performance metrics be perfect. Nor must the use all available information to improve performance of the parallel bulk IO operation. However, these factors can be used, for example, to select chunk boundaries, to select PDisks and VDisks to use for tasks, and for timing of which portions of the extent are being processed.

In step 1140 of FIG. 11, loads on the storage devices that might be used in the bulk IO operation are assessed based on historical patterns and monitoring. It should be noted that some embodiments might use only historical patterns, others might use only monitoring, and others, like the illustrated embodiment, might use both to assess load. Estimation based upon historical patterns would be based upon data from which statistical estimates might be calculated and forecasts made using models well-known to practitioners of the art. Such data may have been collected from the storage system for time periods ranging from seconds to years. A large number of techniques are well-known that can be used for such forecasting. These techniques can be used to build tools, embodied in software or hardware logic, that might be implemented within the storage system 100, for example by the controller 105.

For example, a time series analysis tool might reveal a periodic pattern of unusual load (unusual load can be heavy or light) upon a specific storage device (which might be a VDisk 125 or PDisk 120). A tool might recognize a specific sequence of events, which might occur episodically, that presage a period of unusual load on a storage device. Another tool might recognize an approximately simultaneous set of events that occur before a period of unusual load. Tools could be built based on standard statistical techniques to recognize other patterns as well as these.

Load can also be estimated upon monitoring of the storage devices themselves, at the PDisk 120 level, the VDisk 125 level, or the level of a storage array or RAID 810. Some factors affecting load that can be monitored include queue depth (including operations pending or in progress); transactional processing speed (IO operations over some time period, such as one second); bandwidth (e.g., megabytes transferred over some time period); and latency. Some PDisks 120, such as rotational media drives, exhibit some degree of thrashing, which can also be monitored.

In step 1150 of FIG. 11, based upon performance information, contention avoidance, and load assessment, chunks 800 of data on specific storage devices are selected and the chunks 800 are assigned to tasks 1220. Recall that by a chunk 800 we mean a subextent 800 on a VDisk 125 (or, in some cases, a PDisk 120) to be handled by a task 1220. The tasks 1220 execute simultaneously (or quasi-simultaneously by time splitting). Performance information gathered on various elements of the virtualization configuration 128, load assessment, and contention avoidance have already been discussed. These factors alone and in combination affect how tasks 1220 are assigned to chunks 800 of data on particular storage devices at any given time. An algorithm to take some or all of these factors into account might be simple or quite sophisticated. For example, given a mirror pair including a slow and a fast device, the fast device might be used in the operation. The size of a chunk 800 might be chosen to correspond to be equal to the size of a stripe on a PDisk 120. Chunk size can also take into account the relationship between performance (say, in terms of bandwidth) and the size of a packet (a word we are using generically to represent a quantity of data being transmitted) that would be transmitted through the storage system communication system 110. A less heavily loaded device (PDisk 120 or VDisk 125) might be chosen over a more heavily loaded one. Tasks executing consecutively should generally not utilize the same rotational media device, because one or more of them will just have to wait in a queue for another of them to finish completion.

Load assessment and assignment of tasks 1220 to chunks 800 in the embodiment illustrated by FIG. 11 are shown in this embodiment as being performed dynamically within the main loop (see arrow from step 1190 to step 1140) that iteratively processes the IO operation for all subextents of the top level VDisk 126, before each task 1220 is assigned. In fact, some or all of the assessment, choice of chunks 800 and number of tasks 1220 may be carried out once in advance of the loop. Such a preliminary assignment may then be augmented or modified dynamically during execution of the bulk IO operation.

In step 1160 of FIG. 11, a record is made of which data subextents of the top level VDisk 126 have been processed by the bulk IO operation. The purpose of the record is to make sure all subextents get processed once and only once. In step 1170, tasks 1220 that have been assigned to chunks 800 are executed. Note that the tasks 1220 will, in general, complete asynchronously. If 1190 there is more data to process, then flow will return to the top of the main loop at step 1140. If the task 1220 is run within a thread, then when a task 1220 completes, that thread might be assigned to another chunk 800. Equivalently from a functional standpoint, a completed thread might terminate and another thread might be started up to replace it. Initially, the number of tasks 1220 executing at any time will usually be fixed. Eventually, however, the number of running tasks 1220 will eventually drop to zero. It is possible within the scope of the invention that controller 105 logic might dynamically vary the number of tasks 1220 at will throughout the entire bulk IO operation, possibly based upon its scheme for optimizing performance.

Binary bulk IO operations, and bulk copy operations in particular, are a class of bulk IO operations requiring special treatment because, at the least, some information must be known about two VDisks 125, and both VDisks 125 must be managed individually and jointly to execute the bulk copy operation. Such information may be used to coordinate tasks 1220 reading from a source VDisk 1200 with tasks 1220 writing to a target VDisk 1201 to improve performance. The virtualization configurations 128 of the source VDisk 1200 and the target VDisk 1201 may each be simple or complex. And those virtualization configurations 128 might be similar or quite different. As with the single VDisk 125 operations, the copy operation can be handled with varying degrees of sophistication depending on the complexity of the virtualizations, the availability of information about the virtualization configurations 128, and the amount of performance improvement desired through parallelization.

FIG. 12 is a block diagram illustrating the structure of two VDisks 125 in a parallel bulk copy operation using the Basic Approach. A source VDisk 1200 is implemented with a source virtual configuration 1210, under the control of a source controller 1230. A target VDisk 1201 is implemented with, and mapped 820 to, a target virtual configuration 1211.

The target VDisk 1201 and target virtual configuration 1211 may be under the control of the source controller 1230, or may be under the control of a separate target controller 1231 (shown dashed in the figure to suggest that it is optional). If there is a separate target controller 1231, typically one of the controllers will act as the master in the bulk copy, and the other will act as the slave. Ordinarily, the source controller 1230 will be the master in such a circumstance. Communication between two controllers 105 necessary for such a master-slave relationship can be achieved through the storage system communication system 110 as shown in FIG. 1. The source VDisk 1200 is divided by the source controller 1230 into subextents 800 or chunks 800. The target VDisk 1201 has the same number of chunks 800. Corresponding chunks 800 (e.g., X1 and Y1) have the same sizes.

Typically all chunks 800 (e.g., X1-X4, Y1-Y4) will be the same size using the Basic Approach. The copy operation is carried out with tasks 1220 that copy subextents 800 from the source VDisk 1200 to the target VDisk 1201 in parallel. A variety of ways to implement tasks 1220 are available. For example, tasks 1220 may in some embodiments be implemented as threads. In other, the tasks 1220 may be implemented by requests sent by a controller 105 to PDisks 120 and/or VDisks 125. While, at some point in the bulk copy operation, at least two tasks 1220 will be running, not all tasks 1220 will necessarily run at the same time. For example, in FIG. 12, two tasks 1220 are indicated as impending tasks 1221 by dashed lines. When one task 1220 is completed, typically another will be initiated, and so on until the subextent has been processed.

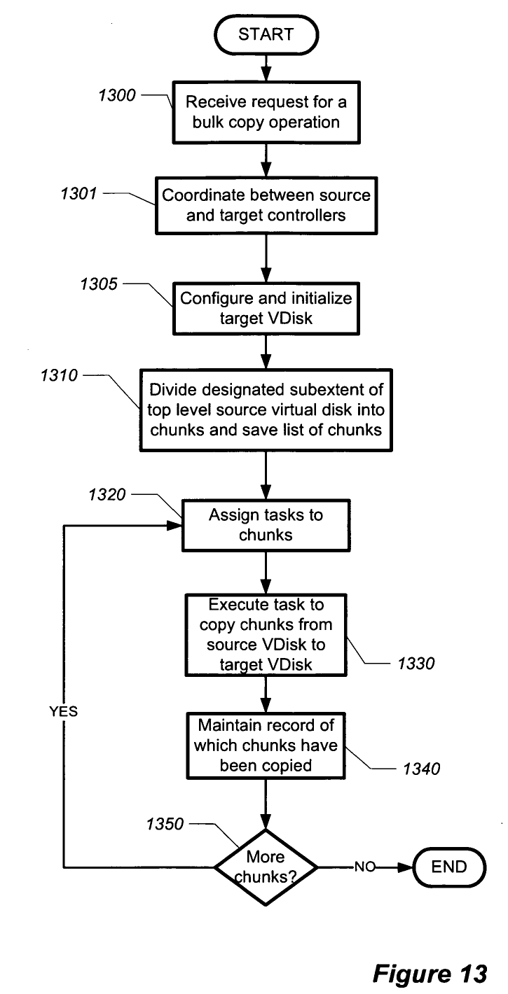

FIG. 13 is a flowchart, corresponding to FIG. 12, that illustrates the process of a parallel bulk copy operation using the Basic Approach in an embodiment of the invention. In step 1300, a request is received by the controller 105 of the source VDisk 1200 for the top level VDisk 126 to perform a bulk copy operation. This request will not come through the facade of the source VDisk 1200, but directly to the source controller 1230. For example, the request might come by an out-of-line request 147. For operations internal to the storage system 100, the controller 105 might already be aware that a bulk IO operation will be performed, and, indeed, the controller 105 might itself be triggering the copy operation either automatically or in response to a user request. The same initial communications may occur as were discussed in connection with 600 of FIG. 6. In addition, the identity of the target VDisk 1201 may be received by the controller 105, and, if the less than the entire target VDisk 1201 is to be written to, then the location on the target VDisk 1201.

If the target VDisk 1201 is managed by a different controller 105, then in step 1301 the two controllers 105 coordinate with each other. (This step is not necessary if both source VDisk 1200 and target VDisk 1201 are managed by a single controller.) For example, the source controller 1230 might act as master and send instructions to the target controller 1231. Or the target controller 1231 might provide the source controller 1230 with information that allows the source controller 1230 to have access to one or more VDisks 125 or PDisks 120 under control of the target controller 1231. In step 1305 of the embodiment shown, the target VDisk 1201 is configured and initialized. In other embodiments, configuration and/or initialization of the target VDisk 1201 may not be necessary; for example, one or both of these operations may have already been performed prior to the start of the process.

In step 1310 of FIG. 13, an extent of the top level VDisk 126 designated to participate in the bulk copy operation (which might be the entire extent of the top level VDisk 126) is partitioned into further subextents 800 or chunks 800 of data. The chunks 800 are listed and the list is saved digitally, as described in connection with step 610 of FIG. 6. The tasks 1220 are assigned to some or all of the chunks 800 in step 1320. In some cases, the tasks 1220 will be run in separate threads. Each task 1220 is typically assigned to a single chunk 800. In step 1330, the tasks 1220 are executed, each performing a read operation on the source VDisk 1200 and a write operation on the target VDisk 1201 for the chunk 800 associated with that task 1220. When a task 1220 completes, in some embodiments a record is maintained 1340 in some digital form to reflect that fact. In effect, the list of chunks 800 would be updated to show the ones remaining. Of course, this step is unnecessary if all the chunks 800 are immediately assigned to separate threads. If 1350 more chunks 800 remain, then tasks 1220 are assigned to some or all of them and the process continues. Otherwise, the process ends.

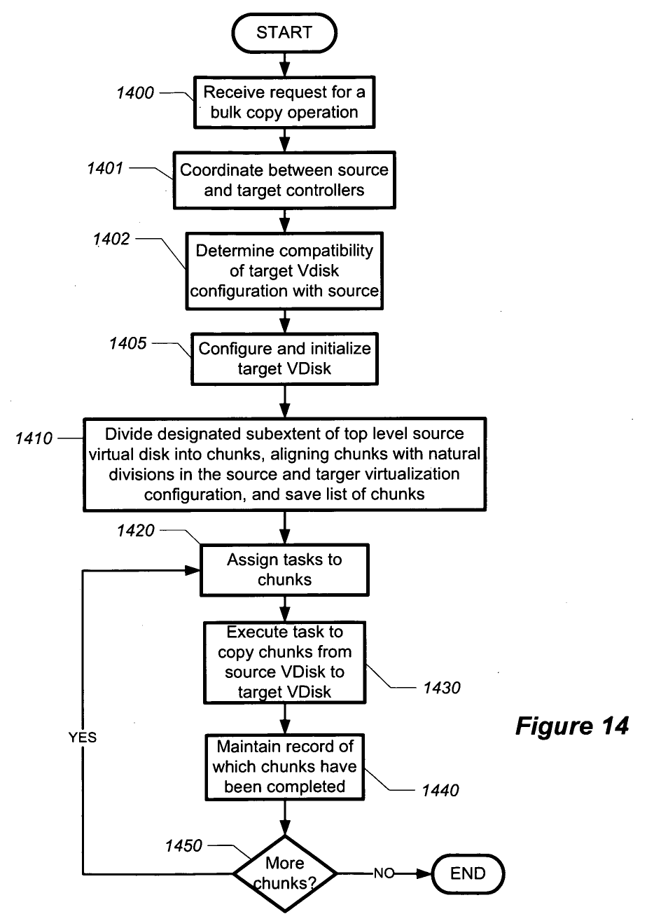

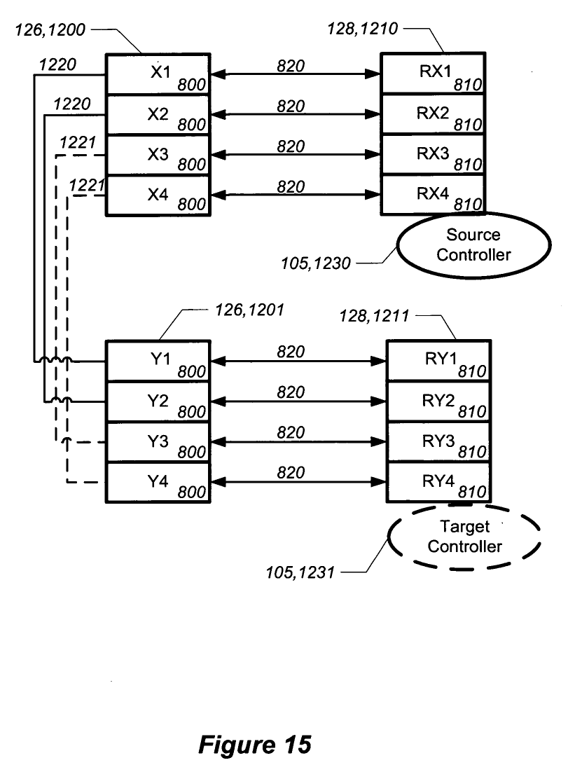

The Basic Approach of FIG. 13 will in most cases reduce the total time for the bulk copy operation being performed, but it ignores the structure of the virtualization configuration 128—for example, structures such as illustrated by FIGS. 15 through 17. The Intermediate Approach, an embodiment of which is shown in FIG. 14, utilizes the virtualization structure more effectively in certain special cases. With the exception of step 1410, steps 1400 through 1450 are identical to their correspondingly numbered counterparts in FIG. 12 (e.g., step 1400 is the same as 1300). Discussion of the repeated steps will not be repeated here. Step 1410 is different from 1310 in that the partition of the extents of the top level VDisk 126 of the source VDisk 1200 and top level VDisk 126 of the target VDisk 1201 results in alignment of the chunks 800 with some “natural” division in the virtualization configuration 128. Some examples of such natural divisions are illustrated by FIGS. 15 through 17.

FIG. 15 is a block diagram illustrating an embodiment of the invention a system in which copying in parallel, or “interleaving,” is used for a bulk copy of a source VDisk 1200 (or a portion of a source VDisk 1200) to a target VDisk 1201, where both VDisks 125 are implemented as a set of RAIDs 810 that each potentially utilize a plurality of PDisks 120. It is this natural division of the extents into RAIDs 810 that qualifies this configuration for the Intermediate Approach. Except as we will now note, the discussion of the Basic Approach for a bulk copy operation, as shown in FIG. 12, generally applies also to FIG. 15 and will not be repeated here (e.g., the discussion regarding subextents 800 of the source VDisk 1200 and the target VDisk 1201, the source controller 1230, the target controller 1231, tasks 1220, and impending tasks 1221). In FIG. 15, however, there is a natural division in that subextents 800 of both the source VDisk 1200 and the target VDisk 1201 are mapped 820 to respective RAIDs 810 by the source virtual configuration 1210 and target virtual configuration 1211.

The details of the embodiment of FIG. 15 (as with all the figures) are merely illustrative of the inventive concept. There can be any number of subextents 800 of the source VDisk 1200 greater than one. Each subextent 800 or chunk 800 is implemented as some form of RAID 810. The subextents 800 of the source VDisk 1200 are mapped 820 to corresponding RAIDs 810, and similarly for the target VDisk 1201. It is important to note that any two of these RAIDs 810 of the source VDisk 1200, such as RX1 and RX2, might have the same or a different configuration.

For example, if X1 is implemented as a RAID 1 mirror by RX1, then X2 might be implemented as a RAID 1 mirror by RX2. Alternatively, X2 might be implemented as in a RAID 5 configuration by RX2. The number of PDisks 120 included in two of the source RAIDs 810 might be the same, or it might be different. The individual source RAIDs 810 might each reside on separate PDisks 120, but in some embodiments some or all of them might share PDisks 120. And while any particular PDisk 120 might be dedicated to the RAID implementation of the source VDisk 1200, that PDisk 120 might alternatively contain data unrelated to that implementation.

The same considerations hold for the subextents 800 and the RAIDs 810 that implement the VDisk configuration 128 on the target VDisk 1201. A corresponding pair of RAIDs 810 from the source VDisk 1200 and the target VDisk 1201, such as RX1 and RY1, might have the same RAID level or not, and might involve the same number of PDisks 120 or not. If the RAIDs 810 both involve striping, the number of stripes used to implement RX1 can be different from that of RY1, and, indeed, RY1 might not involve stripes at all.

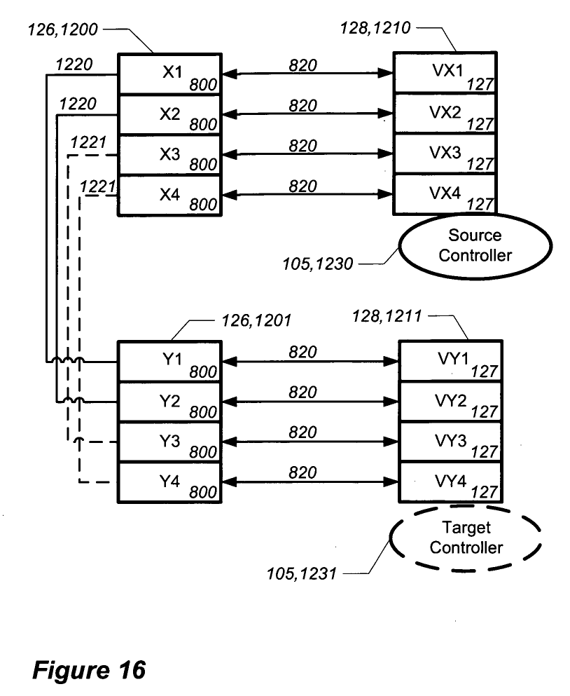

FIG. 16 illustrates an embodiment of the invention that is similar to the class of embodiments shown in FIG. 15. Each subextent 800 of the source VDisk 1200 is implemented as an internal VDisk 127, to which it is mapped 820, forming a pair; similarly, for the target VDisk 1201. It is this natural division of the extents into internal VDisks 127 that qualifies this configuration for the Intermediate Approach. It is important to note that any two of these pairs, such as the ones for the X1/VX1 and X2/VX2 pairs, might have the same or a different configuration. For example, X1 might be implemented as the virtualization VX1, which could be a concatenation of two internal VDisks 127 VX1a and VX1b, where VX1a and VX2b are each configured as three-way mirrors of data on PDisks 120. X2 might be implemented in a RAID 10 configuration. The number of PDisks 120 included in any two of the virtualizations of the internal VDisks 127 might be the same, or it might be different. An individual internal VDisk 127 virtualization might involve a set of PDisks 120 that is distinct from the virtualizations of the other internal VDisk 127, but portions of the same PDisks 120 might be involved in two or more internal VDisk 127 virtualizations. And while any particular PDisk 120 might be dedicated exclusively to an internal VDisk 127 virtualization, that PDisk 120 might alternatively contain data unrelated to any virtualization of a subextent of the source VDisk 1200.

The same considerations hold for the subextents 800 of the target VDisk 1201 and the target virtual configuration 1211. A subextent 800 of the source VDisk 1200 and the corresponding subextent 800 of the target VDisk 1201, such as VX1 and VY1 might or might not be virtualized similarly, and might involve the same number of PDisks 120 or not.

The interleaved process of the present invention utilizes a plurality of tasks 1220 to copy subextents 800 of the source VDisk 1200 to corresponding subextents 800 of the target VDisk 1201. A subextent 800 of the source VDisk 1200 is copied to the corresponding subextent 800 of the target VDisk 1201, and ultimately to the corresponding PDisks 120 according to the target virtual configuration 1211. In some embodiments, the copying is handled by the Intermediate Approach at the level of the virtualization of the concatenated internal VDisks. For example, logic will copy subextent 800 X1 to subextent 800 Y1, one virtual storage cell (e.g., byte) at a time. Ordinarily, this logic will not be aware of how the virtualization of the subextents 800 is implemented, or even that such virtualization exists. The logic simply behaves as if it were copying a subextent 800 of one VDisk 125 to a subextent 800 of another through the virtualization facade. Other embodiments might exploit what the controller knows about the virtualization more aggressively, for example, by a task sending an out-of-line request to an internal VDisk to perform its share of the bulk IO operation. Reading to, and writing from, individual PDisks 120 goes on behind the scene, handled by separate logic. Ordinarily this logic will be handled by one or more controllers 105.

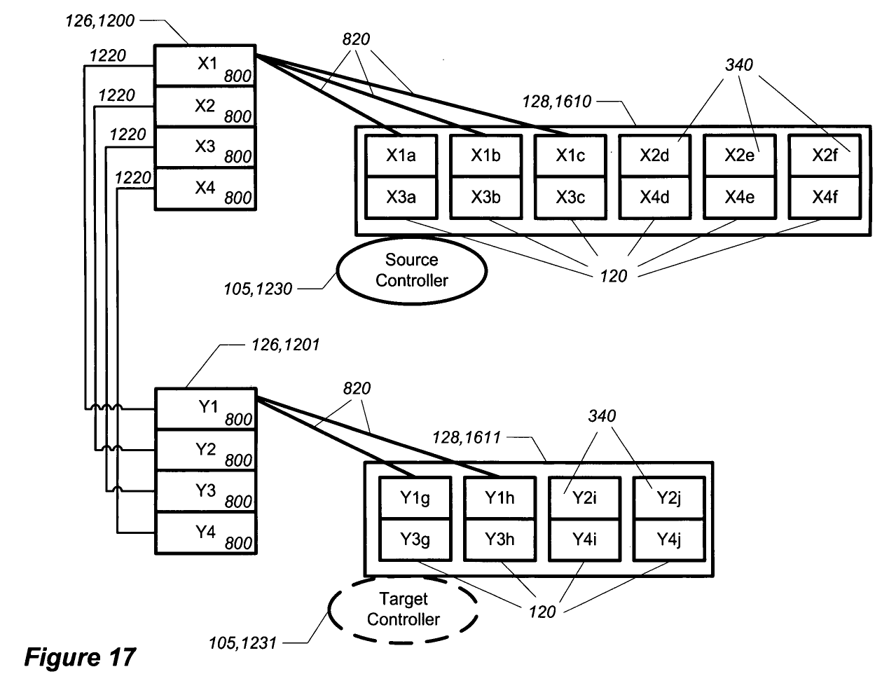

FIG. 17 is a system illustrating embodiments of the Intermediate Approach in which interleaved copying is applied to bulk copying of a source VDisk 1200 to a target VDisk 1201. The source VDisk 1200 is under the control of a source controller 1230. The source VDisk 1200 is implemented by a source virtual configuration 1210 that includes six PDisks 120, indicated a through f. The data content of the source VDisk 1200 is striped over the corresponding PDisks 120. The target VDisk 1201 has a similar target virtual configuration 1211. It is the simple division of the extents into stripes 340 that qualifies this configuration for the Intermediate Approach.

The configuration of the striping corresponds to a logical subdivision of the extent of the data content of the source VDisk 1200 into four subextents 800, labeled X1 through X4. Each subextent 800 of the source VDisk 1200 is striped across three PDisks 120. Twelve stripes 340 are typified by the three (X2d-f, which correspond to subextent 800 X2) tagged with reference numbers in the figure. The subextent 800 X1 is mapped 820 to corresponding stripes 340, labeled X1a through X1c, as indicated by three dark solid lines in the figure. The subextents 800 X2-X4 are mapped 820 correspondingly (mapping not shown). The target virtual configuration 1211 in FIG. 17 is similar to the source virtual configuration 1210. This example illustrates that the source virtual configuration 1210 and target virtual configuration 1211 within the Intermediate Approach. Here the striping schemes of source VDisk 1200 and target VDisk 1201 differ, but they are similar and simple enough that a controller 105 could easily handle division of the extent of the source VDisk 1200 into chunks 800 that would be compatible with both source and target.

The number of subextents 800 of the target VDisk 1201 will always be the same as the number of subextents 800 of the source VDisk 1200, in this case four. The striping configuration implementing the target VDisk 1201 might be the same as that of the source VDisk 1200, or it might be different. Logic, typically in the source controller 1230, must handle such differences in the striping configuration between the source VDisk 1200 and the target VDisk 1201. For purposes of illustration, we chose an embodiment in which the contents of the target VDisk 1201 will be striped in a target virtual configuration 1211 that includes only four PDisks 120, indicated g-j. The subextent 800 Y1 of the target VDisk 1201 is mapped 820 to stripes 340 Y1g and Y1h. Similarly, Y2 is mapped 820 to Y2i and Y2j; Y3, to Y3g and Y3h; and Y4, to Y4 and Y4i and Y4j.

The details of the embodiment shown in FIG. 17 are merely illustrative of the inventive concept. There can be any number of subextents 800 greater than one. Each subextent 800 of the source VDisk 1200 can be striped across any number of PDisks 120 greater than one. Any given PDisk 120 containing a stripe 340 of the source virtual configuration 1210 may also contain data not involved in the source virtual configuration 1210, and it might contain data involved in stripes 340 from two or more of the subextents 800 of the source VDisk 1200. The same considerations are true with respect to the target VDisk 1201 and the target virtual configuration 1211. A single PDisk 120 might contain a stripe 340 from the source VDisk 1200 as well as a stripe 340 from the target VDisk 1201.

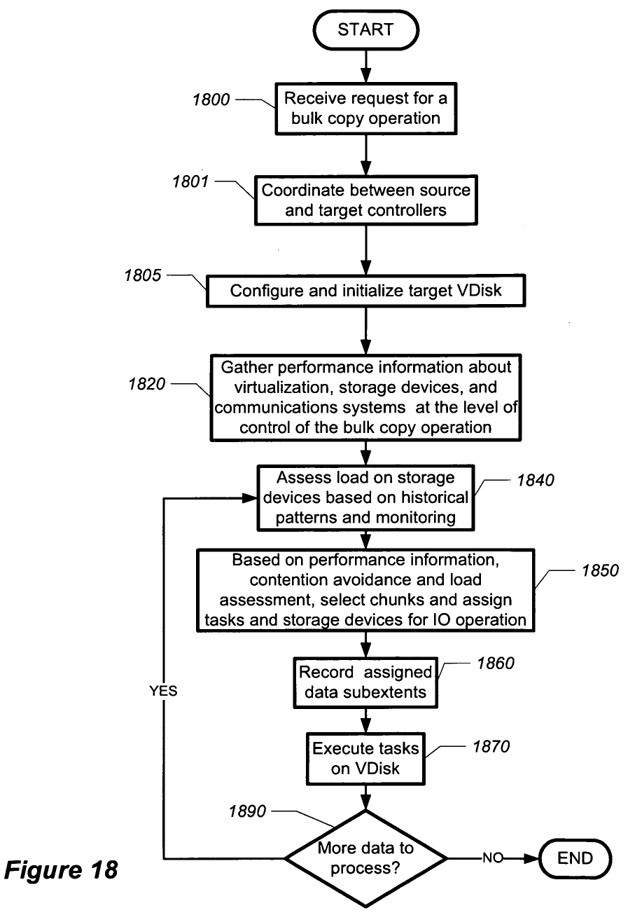

The Intermediate Approach of FIG. 14 takes into account limited information about the source virtual configuration 1210 and target virtual configuration 1211 in some special cases in which there is a natural way of dividing the source VDisk 1200 and target VDisk 1201 into subextents. In the Advanced Approach flowchart of FIG. 18, bulk copy operations for more general configurations of the source VDisk 1200 and/or target VDisk 1201, such as those configurations shown in FIGS. 2 through 5 are handled.

In step 1800, a request is received by a controller 105 (typically the source controller 1230) for a bulk copy operation. The same considerations apply as were discussed in connection with FIG. 13 regarding awareness by the controller 105 of the nature of the IO operation that is being requested. The source controller 1230 and target controller 1231 may coordinate 1801 with each other, as has already been discussed with respect to the Basic and Intermediate Approaches. If the target VDisk 1201 has not already been configured or initialized, those preliminaries can be done 1805 at this point. Information is gathered 1820 at the level in the structure where the bulk copy operation is controlled, for example, the source controller 1230. Examples of the kinds of information that are gathered have already been provided in connection with step 1120 of FIG. 11. However, in this case, information may be required regarding both the source VDisk 1200 and the target VDisk 1201.

Step 1840, the start of the main loop, involves an assessment of load similar to that already discussed in connection with step 1140 of FIG. 18, singly or jointly. As with the information gathering, load may be assessed on either or both of the source VDisk 1200 and the target VDisk 1201. Selection of chunks 800 and their boundaries, and their assignments to tasks 1220, in step 1850 is within the loop and may be done dynamically. That selection is based upon performance information, contention avoidance, and load assessment, and may involve both the source VDisk 1200 and the target VDisk 1201. As previously discussed, analysis of those factors may involve monitoring and/or modeling. For example, a chunk 800 size may be selected that is compatible with stripe sizes on both the source VDisk 1200 and the target VDisk 1201. The decision about selection of which data to process as a chunk 800 at a given time may involve consideration of contention, load, and other factors discussed previously, on both the source VDisk 1200 and the target VDisk 1201. Logic in a controller 105, typically the source controller 1230, will make the decision for the source virtual configuration 1210 and target virtual configuration 1211 jointly. Any of the factors already discussed that affect performance on the source VDisk 1200 singly, target VDisk 1201 singly, or the two jointly may be considered in selection of chunks 800, in timing when a particular chunks 800 to be processed and which VDisks or PDisks to use from the virtualization configuration, and in determination of the number of tasks 1220 to be run at a particular time.

In step 1860 of FIG. 18, a record is made of which data subextents of the top level VDisk 126 have been processed by the bulk copy operation. The purpose of the record is to make sure all subextents get processed once and only once.

In step 1870, tasks 1220 that have been assigned to chunks 800 are executed. Note that the tasks 1220 will, in general, complete asynchronously. If 1890 there is more data to process, then flow will return to the top of the main loop at step 1840. If the task 1220 is run within a thread, then when a task 1220 completes, that thread might be assigned to another chunk 800. Equivalently from a functional standpoint, a completed thread might terminate and another thread might be started up to replace it. Usually, the number of tasks 1220 executing at any time will be fixed. Eventually, however, the number of running tasks 1220 will eventually drop to zero, and typically the drop will be gradual. It is possible within the scope of the invention that controller 105 logic might dynamically vary the number of tasks 1220 at will throughout the entire bulk copy operation, possibly based upon its scheme for optimizing performance.

Embodiments of the present invention in this description are illustrative, and do not limit the scope of the invention. Note that the phrase “such as”, when used in this document, is intended to give examples and not to be limiting upon the invention. It will be apparent other embodiments may have various changes and modifications without departing from the scope and concept of the invention. For example, embodiments of methods might have different orderings from those presented in the flowcharts, and some steps might be omitted or others added. The invention is intended to encompass the following claims and their equivalents.

What is claimed is:

1. A method, comprising:
a) receiving a out-of-line request for a binary bulk IO operation to be performed on an extent of a first virtual disk in a first storage system and a corresponding extent of a second virtual disk in a second storage system, the first and second storage systems being not necessarily distinct, wherein each virtual disk includes a respective virtualization interface that responds to IO requests by emulating a physical disk and is associated by a respective virtualization configuration with a plurality of storage devices that implement that virtualization interface, an out-of-line request being a request that is received through a communication path that does not include the virtualization interface of the virtual disk;
b) partitioning the extent of the first virtual disk into subextents in a first set of subextents and the extent of the second virtual disk into a second set of subextents that correspond to respective source subextents;
c) assigning to each pair, of a subextent in the first set and corresponding subextent in the second set, a respective task in a set of tasks; and
d) executing the tasks in the set of tasks to complete the binary bulk IO operation, at least two of the tasks in the set of tasks executing in parallel over some interval in time.

2. The method of claim 1, wherein the binary bulk IO operation is a bulk copy operation.

3. The method of claim 1, further comprising:
e) obtaining information about the virtual configurations of the first and second virtual disks by a master controller; and
f) using the information to coordinate the binary bulk IO operation between the first virtual disk and the second virtual disk.

4. The method of claim 3, wherein in the step of obtaining information, the master controller receives information from a slave controller about the source virtual configuration or the target configuration.

5. The method of claim 1, further comprising:
e) creating, implementing, or initializing the second virtual disk in response to the request for the binary bulk IO operation.

6. The method of claim 1, further comprising:
e) determining that the virtualization configuration of the first virtual disk permits a natural partition of the first virtual disk into subextents that correspond respectively to subextents in a natural partition of the second virtual disk permitted by the virtualization configuration of the second virtual disk.

7. The method of claim 6, wherein the subextents of the first virtual disk are implemented as RAIDs, the virtualization configuration of the first virtual disk thereby permitting a natural partition of the first virtual disk, and the subextents of the second virtual disk are also implemented as RAIDs, the capacities of RAIDs implementing the first virtual disk being the same as the capacities of the corresponding RAIDs implementing the second virtual disk.

8. The method of claim 6, wherein the subextents of the first virtual disk are implemented as internal virtual disks, the virtualization configuration of the first virtual disk thereby permitting a natural partition of the first virtual disk, and the subextents of the second virtual disk are also implemented as internal virtual disks, the capacities of internal virtual disks implementing the first virtual disk being the same as the capacities of the corresponding internal virtual disks implementing the second virtual disk.

9. The method of claim 6, wherein the subextents of the first virtual disk are implemented as stripes, the virtualization configuration of the first virtual disk thereby permitting a natural partition of the first virtual disk, and the subextents of the second virtual disk are also implemented as stripes, the capacities of internal virtual disks implementing the first virtual disk being the same as the capacities of the corresponding internal virtual disks implementing the second virtual disk.

10. The method of claim 9, wherein the size of a stripe implementing the first virtual configuration and the size of the a stripe implementing the second virtual configuration are each evenly divisible by an integer greater than one.

11. The method of claim 1, wherein a first task and a second task, each in the set of tasks, execute within respective threads.

12. The method of claim 1, further comprising:
e) maintaining a record in digital form of any subextents in the set of subextents that remain to be completed.

13. The method of claim 1, wherein executing a task in the set of tasks utilizes the virtualization interface of the source virtual disk or the virtualization interface of the target virtual disk.

14. The method of claim 1, further comprising:
e) choosing when to execute a particular task in the set of tasks based upon consideration of a factor regarding performance of an element implementing the virtualization configuration of the first virtual disk or an element implementing the virtualization configuration of the second virtual disk.

15. The method of claim 14, wherein the factor is a prediction of external load on a storage device in a particular storage system, the storage device being associated by the source virtualization configuration with the source virtual disk, or by the target virtualization configuration with the target virtual disk, and the external load being load due to processes other than the bulk IO operation.

16. The method of claim 15, wherein the prediction of external load utilizes monitoring of the storage device.

17. The method of claim 15, wherein the prediction of external load utilizes an analysis by a statistical model of historical load on storage devices in the particular storage system.

18. The method of claim 1, further comprising:
e) choosing the boundaries of a first subextent in the first set of subextents based upon consideration of a factor regarding performance of an element implementing the virtualization configuration of the second virtual disk.

19. The method of claim 18, wherein the factor is the dependence of efficiency of transmission by a communication system within second storage system upon the boundaries of a subextent of the second virtual disk.

20. The method of claim 1, further comprising:
e) choosing when to execute a particular task in the set of tasks based upon joint consideration of a first factor regarding performance of an element implementing the virtualization configuration of the first virtual disk and a second factor regarding performance of an element implementing the virtualization configuration of the second virtual disk.

21. The method of claim 1, wherein method is managed by a controller of the first virtual disk.

22. The method of claim 21, further comprising:
e) gathering, by the controller of the first virtual disk, information about implementations of the virtualization configuration of the first virtual disk, and the virtualization configuration of the second virtual disk, regarding storage devices, virtualization relationships among storage devices, and a communications system.

23. The method of claim 22, wherein the first virtualization configuration or the second virtualization configuration contains an abstract node.

24. The method of claim 22, wherein the first virtualization configuration or the second virtualization configuration contains an internal virtual disk.

25. The method of claim 1, further comprising:
e) selecting, after executing of a task in the set of tasks has completed, a starting location and an ending location of a subextent in the first set of subextents.

26. The method of claim 1, further comprising:
e) selecting, after executing of a first task in the set of tasks has completed, a subextent of the first virtual disk using a first performance factor based upon implementation of the virtualization configuration of the first virtual disk and a second performance factor based upon implementation of the virtualization configuration of the second virtual disk; and
f) assigning a second task in the set of tasks to the subextent, selected in the selecting step, and executing the second task.

27. The method of claim 26, wherein the first performance factors in the selecting step includes the performance characteristics of a component of the first storage system.

28. The method of claim 26, wherein the first performance factor in the selecting step includes expected contention, with other tasks of the bulk IO operation, for storage devices in the first virtual configuration.

29. The method of claim 26, wherein the first performance factor in the selecting step includes expected load, from processes not associated with the bulk IO operation, upon storage devices in the first virtual configuration.

30. A system, comprising:
a) a first storage system and a second storage system, not necessarily distinct from the source storage system;
b) a first virtual disk in the first storage system and a second virtual disk in the second storage system, a virtual disk including a virtualization interface that responds to IO requests by emulating a physical disk and being associated by a virtualization configuration with a plurality of storage devices that implement the virtualization interface; and
c) logic, implemented in digital electronic hardware or software adapted to
(i) receiving a out-of-line request for a binary bulk IO operation to be performed on an extent of the first virtual disk and a corresponding extent of the second virtual disk in a second storage system, an out-of-line request being a request that is received through a communication path that includes neither the virtualization interface of the first virtual disk nor that of the second virtual disk,
(ii) partitioning the extent of the first virtual disk into subextents in a first set of subextents and the extent of the second virtual disk into a second set of subextents that correspond to respective source subextents,
(iii) assigning to each pair, of a subextent in the first set and corresponding subextent in the second set, a respective task in a set of tasks, and
(iv) executing the tasks in the set of tasks to complete the binary bulk IO operation, at least two of the tasks in the set of tasks executing in parallel over some interval in time.
